(19) United States
(12) Patent Application Publication
(10) Pub. No.: US 2026/0273405 A1
(43) Pub. Date: Sep. 17, 2026

(54) PHASE-SYNCHRONIZED COMPUTER GAME SYSTEMS AND METHODS BASED ON SEGMENTED AUDIO TRACKS

(71) Applicant: Temerity Games LLC, Eagan, MN (US)

(72) Inventor: Adam Joshua Nicolai, Eagan, MN (US)

(73) Assignee: Temerity Games LLC, Eagan, MN (US)

(21) Appl. No.: 19/562,670

(22) Filed: Mar. 10, 2026

Related U.S. Application Data
(60) Provisional application No. 63/770,038, filed on Mar. 11, 2025.

(51) Int. Cl. A63F 13/54; A63F 13/798

(52) U.S. Cl. CPC A63F 13/54; A63F 13/798

(57) ABSTRACT

Computer-implemented game systems and methods are disclosed in which gameplay is partitioned into multiple discrete phases synchronized to segments of a fixed-length, non-looping audio track. A song map may define phase boundaries, gameplay configurations, and transition parameters corresponding to musically meaningful sections of the audio. At runtime, one or more processors may monitor audio playback position and automatically transition between gameplay phases at predefined boundaries without requiring player input to initiate such transitions. Gameplay mechanics, environments, objectives, difficulty parameters, or grouping configurations may vary between phases. Performance metrics from a completed phase may influence subsequent phase configuration, including regrouping of competitors, conditional phase selection, or score normalization. Phase outcomes may be aggregated using weighted or normalized scoring policies to determine a final result at completion of the audio track. Automated or semi-automated systems may generate segmentation data and phase mappings using signal processing and rule-based or machine learning techniques.

### CROSS-REFERENCE TO RELATED APPLICATIONS

This application claims the benefit of U.S. Provisional Patent Application No. 63/770,038, filed Mar. 11, 2025, titled “Phase-Synchronous Musical Computer Gameplay,” the entire disclosure of which is incorporated herein by reference for all purposes. This application is a non-provisional application claiming priority to the aforementioned provisional application.

### FIELD OF THE DISCLOSURE

The present disclosure relates generally to computer-implemented video games. More particularly, it concerns systems and methods for structuring a multiplayer game session into time-synchronized phases aligned with musically meaningful segments of a predetermined fixed-length, non-looping audio track. In various embodiments, the system supports competitive gameplay with performance-based regrouping of players between phases and phase-normalized scoring to maintain competitive balance. Although certain examples herein describe competitive multiplayer scenarios for clarity, the disclosed phase-synchronous architecture is not limited to competitive gameplay. The described systems and methods are equally applicable to cooperative multiplayer configurations, hybrid competitive-cooperative modes, and single-user implementations in which one or more additional participants are controlled by artificial intelligence systems. References to competitive gameplay should therefore be understood as illustrative rather than limiting.

### GENERAL BACKGROUND

Music-synchronized video games are known in the art. Traditional rhythm-action games (for example, Beat Saber by Beat Games, and the Guitar Hero and Rock Band series by Harmonix) synchronize player inputs or actions to musical beats or note patterns and generally treat a song as one continuous gameplay sequence. These rhythm games typically maintain a single mode or set of mechanics throughout the duration of a song. Some titles allow special modes to be activated, but such transitions are usually triggered by player input rather than being tied to predetermined song segments. Conventional rhythm games typically do not change the core game genre or objectives mid-song, nor do they regroup players during the song; all players generally play concurrently in the same mode from start to finish, either cooperatively or in parallel competition on score.

Competitive multiplayer games in non-music genres (e.g., racing or combat games) often run either as a single continuous match or as a series of discrete rounds, and many employ dynamic difficulty adjustment techniques to maintain close competition. For example, certain racing games may continuously modify game parameters—like giving slower players catch-up items or subtly adjusting leading players' performance—to prevent any one player from getting too far ahead. These adjustments happen invisibly during gameplay and are not structured as explicit phase breaks or rule changes tied to an external timeline. There is no concept of dividing a single match into segments governed by an external medium like a song, and no resetting of the competitive conditions at interim points; the competition is one uninterrupted session per race or round.

Some music-based games introduce multiple sequential segments or mini-games within a single track, but typically only in single-player or cooperative contexts. For instance, Floor Kids (Hololabs, 2017) is a rhythm game where each song is divided into sections (e.g., freestyle vs. choreographed segments), and Nintendo's Rhythm Heaven series includes “Remix” levels that string together different rhythm mini-games sequentially along one song. Similarly, Just Shapes & Beats (Berzerk Studio, 2018) presents a fixed music track during which players evade visual patterns synchronized to musical events; if a player fails, the level may end or restart, rather than dynamically adjusting the ongoing session. These titles demonstrate scripted changes aligned to music, but they do not involve competitive player-versus-player regrouping or fundamental rule changes between segments in an ongoing multiplayer match. In other words, no existing game is known to dynamically reconfigure a live competitive multiplayer matchup at song-defined breakpoints. If multiple players are involved, they typically remain in the same group or match for the entire song, and if a player is eliminated or falls out of sync, the game usually ends or that player is simply removed, rather than reorganizing the competition for the remainder of the song.

Prior approaches have not provided a general-purpose game architecture in which a fixed, non-looping song dictates the progression of gameplay through multiple distinct phases. Switching game modes or contexts at arbitrary times in a session can be technically challenging and potentially disruptive to players (e.g., sudden changes in world mechanics could nullify a player's lead or cause confusion), and continuous matches without breaks can allow early advantages to snowball. Accordingly, there is a need for software architectures and design workflows that enable a multiplayer game to be tightly synchronized to the sectional structure of a song in a way that remains technically seamless, understandable to players, and competitively fair.

### BRIEF DESCRIPTION OF THE DRAWINGS

By way of example, reference will now be made to the accompanying drawings, which are not to scale. The accompanying drawings, which are incorporated in and constitute a part of this specification, illustrate exemplary embodiments and, together with the description, serve to explain principles of the disclosed subject matter. The drawings are not necessarily to scale. Like reference numerals refer to like elements throughout. Certain details or components may be omitted from the diagrams for clarity of illustration. In the drawings:

FIG. 1 is a flowchart of an exemplary phase synchronization pipeline, including (i) song suitability assessment, (ii) level conceptualization and development, and (iii) runtime gameplay execution.

FIG. 2 is a flowchart illustrating an exemplary song assessment process used to determine whether a candidate song is suitable for phase-synchronous gameplay.

FIG. 3 illustrates an exemplary assessment output for a first candidate song, including an identified segment timeline, example segment configuration sets, and a key describing segment suitability and adjustment strategies.

FIG. 4 illustrates an exemplary assessment output for a second candidate song, including identified segment durations (with a highlighted solo section) and example segment configuration sets with a corresponding key.

FIG. 5 is a flowchart illustrating an exemplary level design process that uses song assessment outputs to create a phase-synchronous game level, including conceptual phase planning and development of a song map with associated gameplay configurations.

FIG. 6 is a generalized exemplary diagram of a runtime gameplay process in which a game level lane and a song timeline progress through multiple phases, including playable phases, transition intervals, and a final level conclusion.

FIG. 7, comprising parts 7A-7M, is an exemplary timeline diagram illustrating a specific example of song-aligned gameplay progression for a song of approximately 3:11 (i.e., three minutes, eleven seconds) in length, showing the timing of six playable phases interspersed with transition intervals and concluding with a results display interval.

FIG. 8 is a block diagram of an exemplary computing system that may be used to implement one or more components of the disclosed systems and methods.

FIG. 9 is a diagram of an exemplary networked environment in which one or more servers and multiple client devices implement phase-synchronous multiplayer gameplay.

### DETAILED DESCRIPTION

Those of ordinary skill in the art will realize that the following description of the present invention is illustrative only and not in any way limiting. Other embodiments of the invention will readily suggest themselves to such skilled persons upon their having the benefit of this disclosure. Reference will now be made in detail to specific embodiments of the present invention, as illustrated in the accompanying drawings. The same reference numbers will be used throughout the drawings and the following description to refer to the same or like parts.

Certain figures in this specification are flow charts illustrating methods and systems. It will be understood that each block of these flow charts, and combinations of blocks in these flow charts, may be implemented by computer program instructions. These computer program instructions may be loaded onto a computer or other programmable apparatus to produce a machine, such that the instructions that execute on the computer or other programmable apparatus create structures for implementing the functions specified in the flow chart block or blocks. These computer program instructions may also be stored in computer-readable memory that can direct a computer or other programmable apparatus to function in a particular manner, such that the instructions stored in computer-readable memory produce an article of manufacture including instruction structures that implement the function specified in the flow chart block or blocks. The computer program instructions may also be loaded onto a computer or other programmable apparatus to cause a series of operational steps to be performed on the computer or other programmable apparatus to produce a computer-implemented process such that the instructions that execute on the computer or other programmable apparatus provide steps for implementing the functions specified in the flow chart block or blocks.

Accordingly, blocks of the flow charts support combinations of structures for performing the specified functions and combinations of steps for performing the specified functions. It will also be understood that each block of the flow charts, and combinations of blocks in the flow charts, can be implemented by special purpose hardware-based computer systems that perform the specified functions or steps, or combinations of special purpose hardware and computer instructions.

For example, any number of computer programming languages, such as C, C++, C#(CSharp), Perl, Ada, Python, Pascal, SmallTalk, FORTRAN, assembly language, and the like, may be used to implement aspects of the present invention. Further, various programming approaches such as procedural, object-oriented or artificial intelligence techniques may be employed, depending on the requirements of each particular implementation. Compiler programs and/or virtual machine programs executed by computer systems generally translate higher-level programming languages to generate sets of machine instructions that may be executed by one or more processors to perform a programmed function or set of functions.

In the descriptions in this document, certain embodiments are described in terms of particular data structures, preferred and optional enforcements, preferred control flows, and examples. Other and further applications of the described methods, as would be understood after review of this application by those with ordinary skill in the art, are within the scope of the claimed invention.

The term “machine-readable medium” should be understood to include any structure that participates in providing data that may be read by an element of a computer system. Such a medium may take many forms, including but not limited to, non-volatile media and volatile media. Non-volatile media include, for example, optical or magnetic disks and other persistent memory such as devices based on flash memory (such as solid-state drives, or SSDs). Volatile media include dynamic random access memory (DRAM) and/or static random access memory (SRAM). Common forms of machine-readable media include, for example and without limitation, a floppy disk, a flexible disk, a hard disk, a solid-state drive, a magnetic tape, any other magnetic medium, a CD-ROM, a DVD, or any other optical medium.

As used herein, the term “computer system” is defined to include one or more processing devices (such as a central processing unit (“CPU”) or graphics processing unit (“GPU”)) for processing data and instructions that are coupled with one or more data storage devices for exchanging data and instructions with the processing unit, including, but not limited to, RAM, ROM, internal SRAM, on-chip RAM, on-chip flash, CD-ROM, hard disks, and the like. Examples of computer systems include everything from a controller to a mobile computing device to a laptop or desktop computer, to a super-computer. The data storage devices can be dedicated, i.e., coupled directly with the processing unit, or remote, i.e., coupled with the processing unit over a computer network. It should be appreciated that remote data storage devices coupled to a processing unit over a computer network can be capable of sending program instructions to the processing unit for execution. In addition, the processing device can be coupled with one or more additional processing devices, either through the same physical structure (e.g., a parallel processor), or over a computer network (e.g., a distributed processor). The use of such remotely coupled data storage devices and processors will be familiar to those of skill in the computer science arts. The term “computer network” as used herein is defined to include a set of communications channels interconnecting a set of computer systems that can communicate with each other. The communications channels can include transmission media such as, but not limited to, twisted pair wires, coaxial cable, optical fibers, satellite links, or digital microwave radio. The computer systems can be wide-area networks (WANs) distributed over large, or “wide,” areas (e.g., over tens, hundreds, or thousands of miles), or local-area networks (LANs) (e.g., distributed over several feet to hundreds of feet). Furthermore, various local-area and wide-area networks can be combined to form aggregate networks of computer systems. Descriptions of well-known computing techniques or components may be abbreviated or omitted so as not to obscure the principles of the disclosed embodiments.

Certain figures illustrate processes at a high level. It will be understood that each block or step in these process diagrams may represent one or more executable software instructions or operations that can be implemented by specialized or general-purpose computing hardware. For example, the steps can be carried out by program instructions executed by a processor of a computer system or gaming device. These program instructions may be stored in a non-transitory computer-readable medium and loaded into memory to configure the processor to perform the specified functions. The steps may also be embodied in special-purpose hardware or firmware, or in a combination of hardware and software.

Unless otherwise indicated, the terminology used herein is for the purpose of describing particular embodiments only and is not intended to be limiting. As used herein, terms like “including” or “comprising” are to be interpreted as open-ended, meaning “including, but not limited to.” The term “or” is inclusive, meaning “and/or.” Unless the context clearly requires otherwise, singular articles such as “a” or “an” include the plural forms as well. Likewise, ordinal terms like “first” and “second” are used for distinguishing elements and do not imply any particular order or priority unless explicitly stated. The term “coupled” encompasses direct or indirect connections (e.g., elements that are electrically or communicatively coupled may be in direct contact or may interact via one or more intermediaries).

### Definitions

“Phase” refers to a time-bounded interval of gameplay within a match that corresponds to a specific, defined interval of a predetermined audio track. A “discrete audio track” refers to a non-looping audio track with a defined beginning and ending. A phase is typically delimited by predetermined start and end times or cue points in the audio track. A phase may be a playable phase, during which players have control of their avatars or game elements (e.g., a round of gameplay), or a non-playable phase/interval, during which normal gameplay is suspended (e.g., a transition cinematic or an intermission for displaying scores or results). As used herein, the term “player” or “participant” refers to any entity participating in gameplay, including but not limited to a human user, an artificial intelligence-controlled agent, a computer-controlled character, or any combination thereof. The term “multiplayer” is used to describe gameplay involving multiple participating entities, whether human-controlled, computer-controlled, or mixed. Unless explicitly stated otherwise, references to competitive gameplay do not exclude cooperative, hybrid, or single-human scenarios in which one or more additional participants are controlled by artificial intelligence systems.

“Associated audio track data” refers to measurable attributes or derived characteristics of an audio track or audio track segment, including but not limited to duration, tempo, intensity, instrumentation characteristics, structural segmentation markers, beat or bar alignment information, and other signal-derived attributes usable for determining gameplay configuration parameters.

“Song map” refers to a data structure (or collection of data) that defines the segmentation of a particular audio track into phases and associates each phase with corresponding gameplay parameters or configurations. The song map specifies (i) the timing of phase boundaries (e.g., timestamps or beat measures in the audio track where each phase starts and ends) and (ii) phase-specific data such as the type of gameplay or rule set for that phase, any special events or cues, transition instructions, and scoring or grouping rules applicable in that phase. A song map can be created by a level designer or generated algorithmically (or via a combination of manual and automatic processes), and is used at runtime to synchronize the game with the music.

“Phase boundary” denotes a designated point in the audio track's timeline at which the system transitions from one phase to the next. A phase boundary may coincide with a musically meaningful moment, such as the end of a verse and the beginning of a chorus, a beat drop, or another significant musical cue. These boundaries are typically predefined in the song map so that transitions occur at intended points in the music.

“Podding” (also referred to as dynamic grouping or regrouping) refers to dividing players into subgroups or “pods” that compete or collaborate separately during a given phase. Podding can involve splitting players into different parallel gameplay instances for a phase (while all pods remain synchronized to the same audio track). The composition of pods can change at phase boundaries based on player performance or other criteria—for example, top performers from one phase may be grouped together in the next phase while others are grouped separately. Pods may also be merged at certain points, so that players who were separated for a while are brought back into competition with each other in later phases.

“Phase-normalized scoring” refers to a scoring or ranking scheme in which each phase of the game produces a result (points, rank, etc.) for each player, and these per-phase results are combined in a way that prevents one early phase from determining the entire outcome. In other words, the scoring is normalized or weighted phase-by-phase to ensure that a strong performance in one phase does not create an insurmountable lead. Examples of phase-normalized scoring include resetting scores at the start of each phase and awarding rank-based points instead, capping the maximum advantage one can carry from one phase to the next, or weighting later phases more heavily than earlier ones. The goal is to keep the competition fair and exciting through the final phase of the song.

### Overview of Exemplary Phase-Synchronous Gameplay Architecture

In exemplary embodiments, a gameplay session is structured as a sequence of distinct gameplay phases that are synchronized to corresponding segments of a fixed, non-repeating audio track (for example, a popular song). Rather than relying on beat-by-beat timing for player inputs (as rhythm games do), the disclosed architecture uses the higher-level structure of the song (intro, verse, chorus, bridge, etc.) as a timeline for orchestrating major changes in gameplay. The progression of the game is thereby tied to the musical progression of the song. As the song reaches each new section, the game automatically transitions into a new phase with potentially different gameplay rules or content. These transitions occur at predetermined points in the music, not in response to any player's actions, ensuring that all players experience the change simultaneously and in harmony with the song's flow. Each phase can thus offer a fresh gameplay experience (e.g., a new objective, mechanic, challenge, genre, or environment) aligned with the mood or intensity of that portion of the music.

One challenge addressed by this architecture is that many game genres (such as racing, shooter, or battle royale games) assume a persistent world and continuous progress; abruptly changing the game mode or resetting conditions mid-match can confuse players or negate their achievements. To mitigate this, the system coordinates phase transitions with musically meaningful boundaries and employs brief transition intervals (often designated as non-playable segments) to smooth the handoff between phases. During these transition intervals, the game may temporarily revoke player control and present a visual or audio cue (for example, a short cinematic, a camera effect, or a “phase break” animation synchronized to a drum fill or other musical cue) while loading any new assets or repositioning game elements for the next phase. This way, when the next playable phase begins (ideally timed to a downbeat or the start of a new section in the song), players can seamlessly continue in a new context without jarring discontinuities. The use of the song's structure for timing means that these transitions feel natural and expected (for instance, a big change happening right at the start of a chorus or bridge), which helps maintain player immersion and understanding despite the shifts in gameplay.

In competitive multiplayer implementations, the disclosed system further introduces performance-based dynamic regrouping (“podding”) and phase-normalized scoring between phases. At one or more phase breaks, the system evaluates how each player performed in the phase that just concluded (using whatever metrics are relevant, such as points scored, finishing rank, survival time, objectives completed, etc.) and uses those metrics to rearrange the players into new competitive groupings for the next phase. For example, the top half of players may be placed in one pod and the bottom half in another for the upcoming phase, effectively creating separate brackets or match instances that run in parallel. This podding mechanism can serve multiple purposes: it can create a tournament-like elimination or advancement structure over the course of the song, it can limit the number of players competing directly in a given phase to avoid overcrowding or performance issues, and it can increase the intensity of competition by having players face others of similar skill or performance level as the match progresses. Pods may remain separate for one or more phases and could be merged again in a later phase (for instance, bringing all remaining players back together for a final showdown in the last chorus). Importantly, regardless of pod splits, all players are still synchronized to the same master audio track timeline, so phase transitions and the song's ending occur simultaneously for everyone.

In addition to performance-based regrouping, phase allocation may be determined based on each participant's spatial state at the conclusion of a preceding phase. In certain embodiments, the system evaluates one or more positional parameters of a participant within the game world at or near a phase boundary, including but not limited to world coordinates, elevation, zone membership, region identifiers, environmental interaction states, or physics states (e.g., falling, submerged, airborne, immobilized). Based on such evaluated spatial attributes, the system may assign the participant to a different subsequent phase instance, gameplay environment, or ruleset.

For example, in a cooperative or competitive scenario occurring within a frozen lake environment, participants whose avatars have fallen through the ice at the time the phase concludes may be assigned to a subsequent underwater cave phase, while participants remaining above the ice surface may transition to a mountainous or surface-based phase. The assignment may occur automatically at the phase boundary without requiring participant input and may be executed by the phase management module in coordination with the grouping module.

Such spatially conditioned phase transitions may be applied regardless of whether the session includes multiple human participants, multiple artificial intelligence-controlled participants, or a single human participant interacting solely with the environment. In a fully single-participant embodiment, spatially conditioned phase transitions may operate as a branching progression system in which the participant's physical state or world position at the conclusion of a phase determines the configuration, environment, objectives, or difficulty parameters of the subsequent phase. This allows dynamic multi-path gameplay progression while maintaining synchronization with the predetermined audio timeline.

In certain embodiments, spatially conditioned podding may also serve to limit the number of participants within a given gameplay environment to maintain performance constraints, manage visual clarity, or enhance cooperative coordination. Participants may therefore be reassigned to distinct but temporally synchronized phase instances based on spatial clustering, zone occupancy thresholds, or environment-specific triggers detected at the phase boundary.

In addition to performance-based regrouping determined by score, rank, or other outcome metrics, phase placement may be determined based on a participant's physical position within the virtual world at or near a phase boundary. In certain embodiments, the system evaluates spatial state parameters of each participant, including world coordinates, region membership, elevation, collision state, environmental interaction state (e.g., submerged, airborne, immobilized), or proximity to defined geographic triggers. Based on such spatial attributes, the phase management system may assign the participant to a subsequent phase instance, environment, or ruleset that differs from those assigned to other participants. For example, in a frozen-lake gameplay environment, participants whose avatars remain on the surface at the conclusion of a phase may transition to a mountainous or surface-based phase, while participants that have fallen through the ice may transition to an underwater cave phase. Spatially conditioned phase assignment may operate independently of performance metrics, although level design may intentionally correlate physical position with skill-based outcomes in certain embodiments. This mechanism allows dynamic branching, environmental differentiation, or participant redistribution based on in-world state while preserving synchronization with the predetermined audio timeline.

Additionally, each phase yields its own outcome or score for each player, and the system combines these outcomes using a phase-normalized scoring scheme. By resetting or scaling the scores at each phase boundary (or by converting absolute performance into relative rank-based points per phase), the system prevents any player from accumulating an insurmountable lead early on. This maintains uncertainty and excitement-players who fell behind in early phases can still catch up in later phases if they perform well, especially if later phases are weighted more heavily or have more points at stake. As a result, the final winner or ranking is determined by performance across the entirety of the song, and the competition remains close until the end. This approach contrasts with conventional continuous scoring, where a big early lead often guarantees victory. Here, a dramatic comeback in the final chorus is possible and encouraged by design. The combination of musically timed phase changes, dynamic player regrouping, and per-phase score normalization yields a multiplayer experience that stays fair and engaging from the first note of the song to the last.

### End-to-End Exemplary Level Development and Gameplay Pipeline

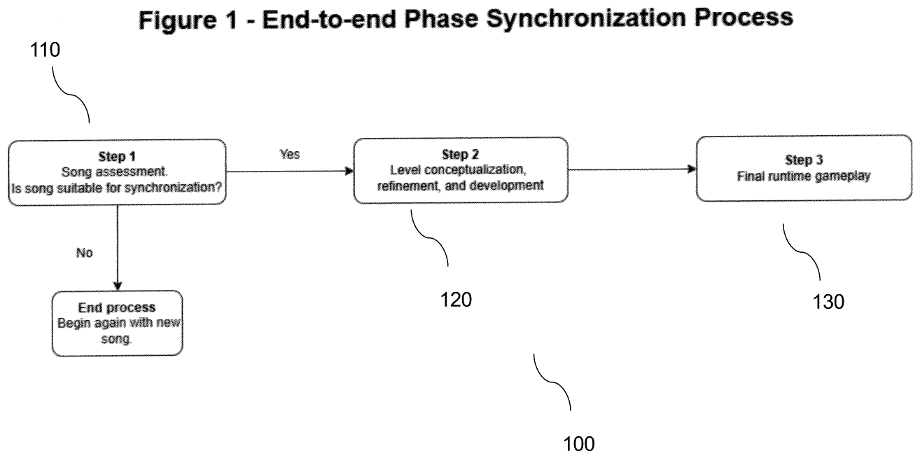

FIG. 1 illustrates an example end-to-end pipeline 100 for implementing phase-synchronous gameplay. This pipeline encompasses the entire lifecycle of creating and running a phase-synchronized game level using a given song, divided into three broad stages: Step 1: Song Assessment 110, Step 2: Level Design and Development 120, and Step 3: Runtime Gameplay Execution 130.

In Step 1 (Song Assessment) 110, a candidate audio track (song) is evaluated to determine whether it is suitable for use in a phase-synchronous gameplay level. In some implementations, the evaluation is performed manually by a designer; in other implementations, the evaluation is performed automatically by one or more computing devices using an audio analysis pipeline that extracts time-frequency and beat-synchronous features, identifies candidate structural boundaries, and computes quantitative suitability metrics. In still other implementations, the evaluation is a hybrid process in which the system proposes candidate segmentation configurations and the designer approves or edits the proposals.

In Step 2 (Level Conceptualization and Development) 120, the designers (and/or a computerized authoring engine) use the song assessment outputs to create a song map and associated gameplay plan for each segment of the audio track. In some implementations, a level authoring tool automatically assigns gameplay phase templates to song segments subject to duration, pacing, asset, and network constraints, generates candidate difficulty and scoring parameters, and produces a preload schedule to support seamless phase transitions, with optional human review and refinement.

Finally, Step 3 (Runtime Gameplay Execution) 130 is where the game is played by end-users (the players) using client devices. A game engine and phase scheduler execute the song map in synchrony with playback of the audio track, transitioning between phases at defined boundaries, dynamically regrouping competitors when configured, and computing per-phase outcomes and overall results.

### Exemplary Song Assessment Process

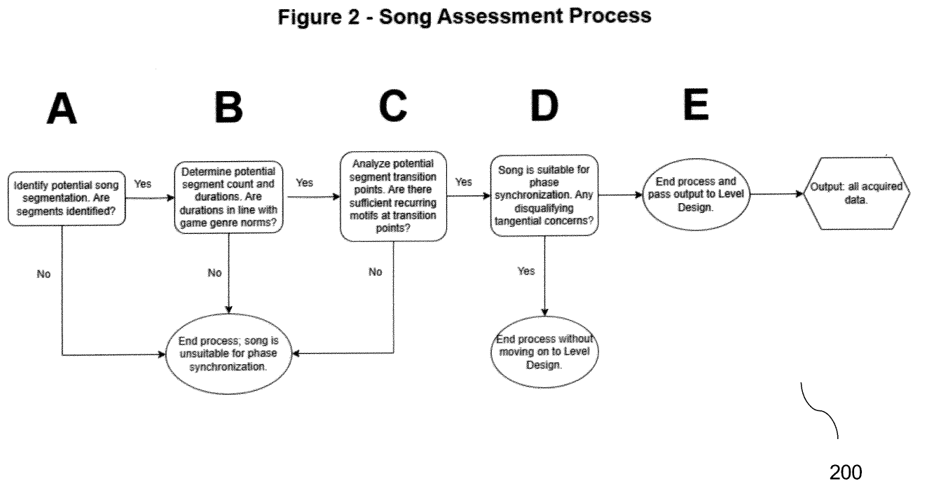

FIG. 2 depicts an exemplary Song Assessment process 200, which is a more detailed view of Step 1 (110) discussed above. This process can be implemented as a software tool to aid designers or as a semi-automated analysis routine. The goal is to determine whether a given candidate song can be effectively used for phase-synchronous gameplay, and if so, to characterize its structure for level development.

Step A: Identify Song Segments. First, the song is assessed for inherent segmentation. Most songs are composed of sections (e.g., verses, choruses, bridges) that are distinct in instrumentation, lyrical content, tempo, or energy. The assessor (human or algorithm) identifies candidate segmentation points in the audio track-moments where one section ends and another begins. These may be detected by analyzing the audio waveform and metadata (e.g., using beat detection, spectral analysis, or known song structure data) or by manual listening. Clear changes like a new verse, a chorus onset, a bridge, a breakdown, a tempo change, or a sustained pause can all indicate potential segment boundaries.

Step B: Determine Segment Durations and Genre Fit. Next, the number of segments and the duration of each proposed segment are evaluated in light of the target game genre or mode. Different game genres have typical or expected durations for levels, rounds, or challenges. For example, if the anticipated game mode is a fighting game, a single round may typically last on the order of 60-90 seconds; for an arcade racing segment, a lap or race may be around 30-120 seconds; puzzle or mini-game phases may be very short (15-30 seconds) or longer, depending on design. The song's candidate segments are reviewed to see how their lengths compare to these genre-specific timing expectations. If some segments are too short to serve as meaningful phases (from a gameplay perspective) or too long to maintain player engagement or fairness, the assessor considers ways to adjust. Short consecutive song segments may be merged into one gameplay phase or repurposed as non-playable intervals (e.g., a 5-second musical bridge could be used as a quick cinematic transition). Conversely, if a single song section is extremely long relative to viable game phase length, the assessor may look for internal points where that section could be split, or may flag the song as problematic if no such split is possible.

Step C: Identify Transition Cues. As part of assessing segmentation, the process checks whether the transition points between segments are accompanied by recognizable aural cues. Ideally, each phase boundary in the song will have a distinctive musical cue—for instance, a drum fill, a cymbal crash, a silence break, or a bass drop—that can be mirrored by a visual or gameplay cue. Recurring motifs are useful; if similar cues appear at each chorus, for example, they can consistently signal phase changes to players. In evaluating the candidate song, the assessor notes whether each prospective phase boundary has an associated cue in the music that can serve to signal the upcoming transition within the game. If a potential boundary lacks any musical signifier (for example, a segment ending in the middle of a sustained note or without a clear delineation), that may be acceptable in some cases but is less ideal, as it could feel abrupt to the player. The best song candidates provide auditory “signposts” for phase transitions.

Step D: Verify Song's Suitability for Gameplay. The process also considers any other factors that may make the song unsuitable for use in a game. This could include practical issues like licensing restrictions, or design issues like an extremely slow fade-out ending that doesn't work well with an action climax. It also includes ensuring the song's content and tone fit the game's context (for instance, lyrics or themes that are inappropriate for the game's audience would be a red flag). If a song has a structural issue identified in steps A-C(e.g., one segment is unmanageably long, or transition cues are lacking) that cannot be resolved by creative level design adjustments, the assessor may mark the song as unsuitable unless certain adjustments are made (such as shortening the gameplay plan or preloading assets to handle a problematic transition). If no fatal flaws are found, the song passes the assessment and moves to the final step.

Step E: Generate Assessment Output and Recommendations. If the song is deemed suitable, the assessment culminates in producing an output dataset or report summarizing the song's structure and recommended usage. This includes the list of identified segments (with their start times, end times, and durations) and different possible configurations of these segments for gameplay phases. For example, the output may enumerate a few ways the segments could be divided or combined to fit the genre's pacing: perhaps one configuration merges two short bridge segments together for a single phase, while another treats them separately but as non-playable intervals. For each configuration, the assessor may note any in-game actions or phase roles that could accompany each segment (e.g., “Segment 1 (Intro, 5 s)—use as cinematic intro; Segment 2 (Verse1, 30s)—standard race phase; Segment 3 (Chorus1, 20s)—battle phase,” etc.). The output often includes one or two formal recommendations for which configuration to implement in the level design, highlighting the option that best balances game pacing with musical structure.

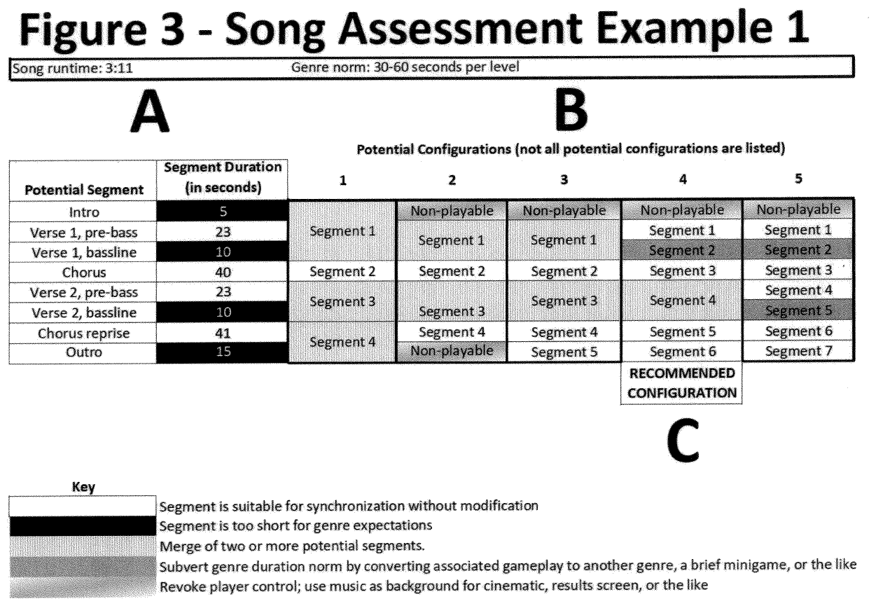

Example 1 (FIG. 3): To illustrate the song assessment process, FIG. 3 provides an exemplary example of evaluating a candidate song for phase synchronization. In this hypothetical case, the song has a clear structure with an intro, verses, and choruses. The assessor first identifies the likely sections of the song by listening and analysis. Suppose the song is roughly 2 minutes long and seems to follow a pattern: a 5-second intro, a 10-second verse, a 15-second chorus, another 10-second verse, a second 15-second chorus, and a 5-second outro. These would be the initial segments identified (3A). The assessor then proceeds through the process steps:

Segmentation: The song's waveform and musical arrangement reveal natural breakpoints at the end of each section. For instance, there is a short pause or distinct change leading into the first chorus, and similarly clear boundaries around the outro. Thus, a preliminary segment list is established.

Segment Duration Check: The segments in this example are quite short (several around 5-15 seconds). If the target game genre expects phases closer to, say, 30-60 seconds, the assessor notes that some segments will need special handling. In this case, the intro (5s) and outro (5s) are very short; the assessor considers using them as non-playable intervals (e.g., an intro cinematic and a final results display) rather than active gameplay phases. The two 10-second verses may be combined or treated as separate short phases depending on design. The 15-second chorus segments are closer to a playable duration, though still on the short side; they could be fine as high-intensity quick phases or combined with an adjacent segment.

Transition Cues: The song has distinct cues at the transition points. For example, the intro crashes into the first verse with a drum hit, and each chorus starts with a recognizable melody hook. These cues will serve as in-game triggers (FIG. 3, marker B)—e.g., a visual flash or an announcer voice when the chorus hits. The recurring nature of the chorus hook helps players anticipate when a big change is coming after a verse.

Suitability: No major issues are found. The song's mood fits the game's theme, and it has multiple interesting musical elements that could map to gameplay events. All segments are usable in some fashion (even if not all as long playable phases). The only potential concern was segment length, but the assessor plans to handle the short segments via merging or using them as transitions, so this is acceptable.

Output: The assessor generates several possible segmentation configurations (3B). For instance, one configuration may merge the two 5-second intro/outro segments with adjacent phases (making the intro part of Verse1's phase and the outro part of Chorus2's phase) to avoid extremely brief standalone phases. Another configuration keeps intro and outro separate as non-playable bookends. The assessor evaluates these options and recommends one: perhaps using the 5-second intro as a cinematic intro phase (no gameplay, just a scene-setting moment), then Phase 1 as the first verse+chorus combined (25 seconds total), Phase 2 as the second verse (10 seconds) leading into Phase 3 as the second chorus (15 seconds), and the 5-second outro as a final results phase. This yields a total of, say, five phases (including two non-playable intervals). Each recommended phase is annotated with ideas (3C)—e.g., “Phase 1 (Verse+Chorus)—core gameplay segment, moderate difficulty; Phase 2 (Verse 2)—bonus challenge phase with increased speed; Phase 3 (Chorus 2)—final showdown phase with high difficulty; Intro/Outro-use for cutscene and results.” With this assessment data compiled, the song is deemed a strong candidate and moves on to level design.

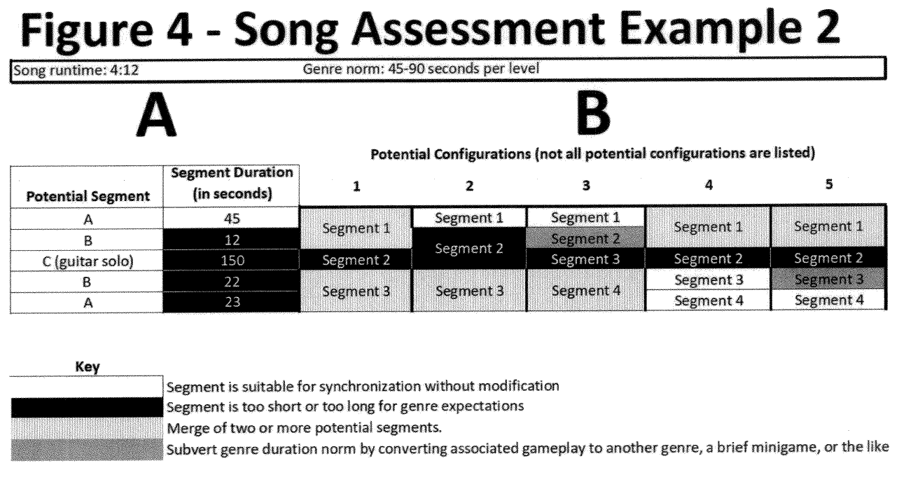

In the FIG. 3 example above, the song was found to be suitable and a particular segmentation plan was chosen. Now consider a different hypothetical song (Example 2, corresponding to FIG. 4) to illustrate a case where the assessment concludes the song is not suitable for phase-synchronous gameplay due to structural issues.

Example 2 (FIG. 4): In this scenario, the candidate song is longer (say 4 minutes 12 seconds) and has a structure that includes a very long guitar solo in the middle. The assessor identifies the rough sections (perhaps an A/B/A pattern where A is a verse/chorus sequence and B is the solo). More specifically, the song may be structured as: Verse-Chorus (“A”), then a different section (“B” for the solo), then back to Chorus (“A” again). Upon closer inspection, the solo section itself could be considered a distinct part “C” sandwiched inside, making the structure A-B-C-B-A (FIG. 4, marker A). The segmentation points are clear, and the song has potential in terms of variety.

However, Duration Check reveals a problem: the guitar solo (the “C” segment) lasts approximately 150 seconds (two and a half minutes) by itself. The other segments (intro, verses, choruses) each fall within a manageable range (let's say under 90 seconds, which may be the maximum desirable phase length for the genre), but this one solo segment far exceeds it. During those 2.5 minutes, there are no obvious internal breakpoints—the solo is continuous and does not pause in a way that would allow splitting into smaller phases. If the game tried to make a single playable phase last the entire 150-second solo, it could violate genre pacing (e.g., a racing or fighting round that long may frustrate players or lead to unbalanced outcomes).

The assessor considers options: could the solo be treated as a non-playable intermission? But 2.5 minutes of non-playable time is likely too long to hold player interest. Could the gameplay span that solo with some creative adaptation? Perhaps if the game genre were something like an adventure or exploration phase, but in a competitive context it would allow a single phase to dominate the match. Ultimately, the assessor determines that despite the song's evocative soundscape, its structure is not compatible with the phase-based design without compromising gameplay. The excessively long continuous segment (the solo) is a fatal flaw for this use case. The song is marked as unsuitable for phase-synchronous gameplay, and the assessment process would recommend not using this track for the game.

These examples demonstrate how the Song Assessment step acts as a filter and guide: it identifies songs that will not likely work well (saving effort down the line) and it provides a blueprint for those that likely will, so that level designers can proceed with confidence that the music will support the intended phase structure.

Feature extraction and segmentation can be executed offline during content preparation, or executed on demand when a new track is uploaded by a user. In interactive authoring tools, the system can cache intermediate feature arrays and recompute only affected segments after a user edit. In some implementations, the system stores beat-synchronous feature vectors and self-similarity matrices in compressed form to reduce memory footprint while maintaining responsiveness.

To support platforms without machine learning capabilities, the system can omit the trained model and rely on deterministic novelty detection and rule-based boundary filtering. In some implementations, the system applies safety constraints to ensure that boundary decisions do not destabilize runtime gameplay. For example, the system can enforce that each phase boundary is separated from the next by at least a minimum playable interval and that each boundary is associated with a cue strength above a minimum threshold when the level requires a visually obvious transition.

In some implementations, the boundary detector is trained on labeled audio tracks with ground-truth boundary annotations. Training data can be augmented by time-stretching, pitch shifting, and adding noise to improve generalization. The model can be trained to minimize a loss function (e.g., binary cross-entropy or focal loss) comparing predicted boundary likelihoods to labels. After training, the model is exported to an inference format suitable for deployment (e.g., ONNX), and the inference pipeline can be executed on CPU, GPU, or dedicated accelerators depending on platform constraints.

In some implementations, the system uses a trained model to predict a boundary probability over time. For example, a convolutional neural network, recurrent neural network, or transformer model can ingest a sequence of feature frames (e.g., mel spectrogram frames) and output a boundary likelihood p [n] for each frame. The system can generate boundary candidates as local maxima of p [n], snap the candidates to nearby beat positions, and use p [n] (or a calibrated variant) as a boundary confidence term in the objective function for segmentation selection.

In some implementations, the system presents a visual interface showing a waveform or spectrogram with proposed boundaries. The interface can allow a user to accept, delete, or reposition boundaries, and to lock specific boundaries. The system can then re-run the optimization while treating locked boundaries as hard constraints and treating user edits as boundary candidates with elevated confidence. In some implementations, the system records an audit trail including the original automated boundaries, the user edits, and the final selected segmentation configuration.

When a track is accepted, the system outputs a machine-readable assessment artifact that can include: selected boundary timestamps, cue strength values, derived beat grid, per-segment feature summaries, and one or more recommended segment roles (e.g., playable, transition, results) based on segment length and cue characteristics. These artifacts can be stored in a repository indexed by a track identifier.

In some implementations, the system computes an overall suitability score S_song for the track based on quantifiable metrics derived from the segmentation candidates. Example components include: (i) an aggregate boundary confidence (e.g., mean or minimum of c_i across selected boundaries), (ii) a duration distribution score measuring how many segments fall within target duration ranges for selected gameplay phase templates, (iii) a transition cue coverage score (e.g., percentage of boundaries meeting a cue threshold), (iv) a structural regularity score that measures whether the track contains repeated sections suitable for repeated mechanics or escalating difficulty, and (v) an execution feasibility score reflecting expected loading and synchronization feasibility (e.g., availability of non-playable intervals at boundaries for asset swaps). The system can classify a track as suitable or unsuitable by comparing S_song to one or more thresholds.

Algorithm 1 (Segmentation Selection)

| Input: beat times B, candidate boundaries P, boundary scores | |
|---|---|
| c(·), duration limits D_min, D_max | |
| Output: selected boundaries C | |
| 1. | dp[i] = −∞ for all beats i; dp[0] = 0 |
| 2. | for each beat i in increasing order: |
| 3. | for each candidate boundary j in P with j>i: |
| 4. | if D_min <= (B[j]−B[i]) <= D_max: |
| 5. | dp[j] = max(dp[j], dp[i] + seg_score(i,j)) |
| 6. | backtrack from last beat to recover C |

One example dynamic programming procedure for selecting a segmentation configuration is shown above. This example uses beat indices for clarity, but the same approach can be used at other granularities:

From a candidate boundary set P, the system generates one or more segmentation configurations C_k={t_0-0, t_1, . . . , t_M=T} that partition the track into M segments satisfying the duration constraints and other design constraints (e.g., a maximum number of phases). In some implementations, the system uses dynamic programming to identify high-scoring segmentations under an objective function. One example objective is: Score (C)=>_{m=1 . . . . M} (w1.c (t_m)+w2.fit (D_m)+w3.rep (D_m, f)-w4.penalty), where c (t_m) is cue strength at boundary t_m, D_m is segment duration, fit (.) rewards segment durations suitable for candidate gameplay genres, rep (.) rewards structural repetition or motif alignment when desired, and penalty discourages excessive segmentation or boundaries with low confidence.

For each candidate boundary, the system can compute a cue strength value c_i intended to quantify how perceptible and musically appropriate the boundary is for a gameplay transition. Example cue terms include a spectral change magnitude, a rhythmic onset peak proximate to the boundary, a brief low-energy gap preceding the boundary, and an alignment to a downbeat. The cue strength can be stored as part of an assessment output and used both for suitability scoring and for selecting a transition presentation (e.g., a brief overlay timed to a downbeat).

Candidate boundary indices can be formed as a union of: (i) peaks in the novelty curve, (ii) peaks in onset strength or spectral flux, (iii) energy drops or silences exceeding a threshold, and (iv) boundaries suggested by a supervised boundary detector. The candidate set is optionally snapped to a musical grid, for example by shifting each candidate boundary to the nearest beat or bar boundary within a tolerance window. The system enforces duration constraints, such as a minimum segment duration D_min (e.g., 8 s) and a maximum segment duration D_max (e.g., 90 s), to exclude trivial or unusable segments.

A self-similarity matrix S (i,j) can be computed from beat-synchronous feature vectors using a similarity metric such as cosine similarity or correlation, S (i,j)=sim (f_i, f_j). The system derives a novelty curve N (i) by convolving a checkerboard kernel along the diagonal of S to detect changes in musical texture that often correspond to section boundaries. Peaks in N (i) above a threshold can be treated as candidate boundaries.

The system aggregates or pools frame-level features into beat-level or bar-level feature vectors f_i. For example, for each beat interval [b_i, b_{i+1}), the system can compute the mean and variance of MFCCs, chroma, and energy, and concatenate the statistics into a vector f_i. In some implementations, f_i additionally includes a confidence value for the beat estimate and an onset peak count within the interval.

In some implementations, the system computes an onset strength envelope o [n] and estimates one or more tempo candidates using autocorrelation, a comb filter bank, or a tempogram-based approach. A beat tracker (e.g., dynamic programming over a state space of beat positions) produces a beat grid B={b_i} mapping each beat to a timestamp (or sample index). Beat-synchronous analysis can improve robustness by aligning structural decisions to musically meaningful timing rather than arbitrary frame indices.

From the STFT and/or mel spectrogram, the system computes one or more features that characterize musical structure. Example features include: (i) spectral flux and onset strength (including per-band onset strengths), (ii) root-mean-square (RMS) energy and energy derivative, (iii) spectral centroid, rolloff, and bandwidth, (iv) mel-frequency cepstral coefficients (MFCCs), (v) chroma vectors or harmonic pitch class profiles, (vi) a percussive-versus-harmonic ratio (e.g., via harmonic-percussive source separation), and (vii) a tempogram or autocorrelation-based rhythmic representation.

The system partitions the sample stream into overlapping frames using a window of N samples (e.g., N=2048) and a hop size H (e.g., H=512). For each frame n, the system computes a short-time Fourier transform (STFT) and corresponding magnitude spectrum. One example STFT is: X[k,n]=Σ_{m=0}\hat{ }/{N−1}x[m+nH]w[m]·exp(−j·2π·k·m/N), where w[m] is a window function (e.g., Hann). The magnitude |X [k,n] | (and optionally a mel-scaled magnitude) is used to derive spectral descriptors.

A candidate audio track can be received as a file (e.g., PCM WAV, AAC, MP3) or as a stream. The system decodes the track into a sequence of digital samples x[t] (e.g., 44.1 kHz or 48 kHz), optionally downmixes stereo to mono, and applies amplitude normalization and, when appropriate, band-limiting or equalization to reduce noise and improve the stability of subsequent feature extraction. In some implementations, the system computes and stores a checksum or content identifier for caching and for later synchronization across networked clients.

In some implementations, one or more computerized processes perform the Song Assessment of FIG. 2 wholly or partially. The computerized processes can analyze a digital audio file to (i) identify candidate musically meaningful segment boundaries, (ii) evaluate whether the audio file is suitable for phase-synchronous gameplay using quantitative metrics, and (iii) generate a segmentation dataset that can be used directly to populate a song map or presented to a human for approval or editing.

### Exemplary Level Design Process

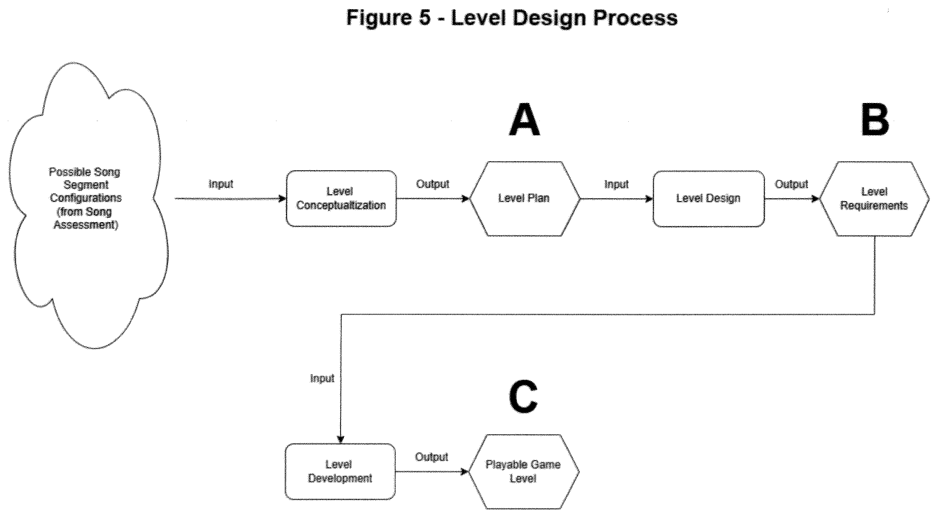

With reference to FIG. 5 of the drawings, an exemplary Level Design process of achieving phase synchronization consists of multiple sub-processes that take the outputs of Song Assessment and turn them into a full-fledged game level. This generally includes Level Conceptualization, Level Refinement, and Level Development stages. These sub-processes are fairly standard in game development (brainstorming the level concept, iterating on design details, and implementing assets and code), but here they are uniquely informed by the song's structure.

During Conceptualization and Refinement, designers use the segment configuration and recommendations from the assessment to map out what happens in each phase of the song. They decide on the game genre or mechanic for each phase, the objectives for players, and how each phase's gameplay will reflect the music. For example, given a chosen song and segmentation, a designer may outline: Phase 1 (Intro)—a cinematic or tutorial moment; Phase 2 (Verse 1)—a racing challenge through a certain environment; Phase 3 (Chorus 1)—a switch to a battle arena where players fight; Phase 4 (Verse 2)—perhaps a skill mini-game or obstacle course; Phase 5 (Chorus 2)—a final confrontation. Alongside these, they plan transitions: e.g., a brief slow-motion effect or a “get ready” screen during a drum fill that transitions verse to chorus.

Level Development then implements these plans in the game engine. The song map data structure is created or updated to include all the phase boundaries and the designated gameplay configuration for each phase. Game logic scripts or state machines are set up to load the correct rules and content at each phase. Art and sound teams prepare any unique visuals, animations, or sound effects needed for phase changes (like a special transition animation that plays at each chorus entry). The development also includes preparing the environments or levels for each phase—these could be entirely different maps or the same map with modifications. Importantly, assets required for later phases may be queued for loading during earlier phases to avoid delay (preloading content based on the song map timeline).

The output of the Level Design process is a phase-synchronized level that is ready to play. It includes the song map (with all phase timings and configurations), the game logic for transitions, and all content (level geometry, enemy placement, items, UI elements, etc.) for each phase. At this stage, the level can be tested end-to-end: when the song is played in the game, the engine should automatically carry players through the planned sequence of phases, applying the correct rules at each step and handling transitions as scripted.

It should be noted that the Level Design can incorporate adaptive or branching structures if desired. For instance, designers may create an alternate phase that will only be used under certain conditions—such as a secret final phase (boss battle or bonus round) that is unlocked only if players collectively achieved a particular goal in earlier phases. In the song map, this could be represented by two possible phase entries at the final segment, with a conditional flag. At runtime, the system checks the condition at the second-to-last phase boundary and either transitions to the normal final phase or to the secret phase accordingly. The timing of the song's segments would remain fixed, but the content of the final segment could differ. Similarly, designers may specify adaptive phase configurations where certain parameters of a phase (e.g., difficulty, number of AI adversaries, or available power-ups) are adjusted based on players' performance in the previous phase. For example, if all players dominated Phase 1, Phase 2 may automatically scale up in difficulty (spawn more obstacles or faster enemies) to keep the challenge. These kinds of dynamic variations are built into the level design rules and encoded in the song map or game scripts. They add replayability and ensure that the phase progression can respond to player skill while still following the predetermined song timeline.

The automated authoring approaches described can reduce manual content preparation effort and can improve the technical operation of the runtime system by producing song maps with explicit timing, asset dependency, and synchronization parameters. For example, preload schedules can reduce runtime stalls at phase boundaries, and deterministic decision tables can reduce the likelihood of client desynchronization in networked play.

Algorithm 2 (Song Map Generation)

| | |
|---|---|
| Inputs: | audio samples x[t], |
| | phase template library L, |
| | platform constraints K |
| Output: | song map M |

| | |
|---|---|
| 1. | boundaries = segment_audio(x[t]) (e.g., Algorithm 1) |
| 2. | for each segment m: |
| | compute g_m; determine role |
| | (playable/transition/results) |
| 3. | for each playable segment m: |
| | candidates_m = {template in L \| |
| | duration_ok(template, m) and |
| | platform_ok(template, K)} |
| 4. | select template_m for each segment by optimizing |
| | assignment objective under constraints |
| 5. | instantiate parameters for each template_m; |
| | generate regrouping and scoring policies |
| 6. | generate preload schedule and runtime packages |
| 7. | output M containing boundaries, template |
| | identifiers, parameters, and policies |

One exemplary end-to-end generation procedure is described above.

The authoring engine outputs (i) a song map data structure that includes segment boundaries, phase types, gameplay configuration identifiers, parameter values, and conditional branching definitions, and (ii) one or more runtime packages such as asset bundles and phase scripts. The song map and packages can be digitally signed and versioned so that clients and servers can verify that all participants in a multiplayer session execute the same configuration.

In hybrid embodiments, a designer can view the automatically generated song map, including each segment's assigned template, parameters, regrouping policy, scoring settings, and preload schedule. The designer can override assignments or adjust parameters. The authoring engine can re-validate the map after edits, re-generate dependent artifacts (e.g., preload schedules), and flag conflicts such as segments too short for a selected template or asset loads exceeding a platform budget.

In some implementations, one or more trained models propose candidate templates or parameter values. For example, a model can ingest segment feature summaries g_m and output a ranked list of phase templates and/or parameter suggestions. The authoring engine can then apply rule-based and constraint-based validation to ensure that selected templates satisfy duration, platform, and synchronization constraints. In some implementations, a separate model predicts an expected engagement score, dropout probability, or fairness metric for a candidate assignment, and the optimization objective incorporates the predictions as terms.

In some implementations, the authoring engine computes an asset dependency set for each phase, including environment geometry, textures, audio cues, animations, and gameplay scripts. The authoring engine can generate a preload schedule that assigns each asset (or asset bundle) to a preload window preceding its phase boundary, based on estimated load time and available bandwidth. One example scheduler uses an earliest-deadline-first policy in which assets required for the next phase are preloaded during the current phase or a preceding transition segment, thereby reducing runtime stalls during phase switches.

In some implementations, the authoring engine defines alternative configurations for one or more later phases and stores a decision table in the song map. The decision table may include conditions evaluated at a phase boundary (e.g., a player rank percentile, a score gap threshold, or a cumulative performance metric) and a mapping from each condition outcome to a selected configuration for the next phase (e.g., a harder variant, a different opponent set, or an alternate environment). To prevent client desynchronization, the decision evaluation can be performed on a server using deterministic arithmetic and communicated to clients as a small decision message identifying the selected branch.

In some implementations, the authoring engine selects a scoring function and normalization policy per phase and for the overall match. For example, the engine can specify rank points for each phase (e.g., 1st=5, 2nd=3, 3rd=2, 4th=1) and specify phase weights w_m. Weights can be selected to maintain suspense by bounding any single phase's maximum contribution to the final score. In some implementations, the engine enforces a constraint max_contrib_m<=C max for each phase m by choosing w_m and/or by applying a compression function to raw scores. Example compression functions include percentile mapping, logistic scaling, and piecewise-linear clipping.

In some implementations, the authoring engine automatically generates a regrouping policy that will be executed at one or more phase boundaries. A regrouping policy can specify whether to split players into pods, how many pods to create, target pod sizes, and a mapping rule from prior phase outcomes to pods. Example mapping rules include: (i) rank-ordered bracket assignment (e.g., top-ranked players grouped together), (ii) balanced assignment that mixes ranks to reduce variance, and (iii) elimination-based assignment in which only a subset of players advance. In contrast to traditional elimination tournament structures, certain embodiments are specifically configured to preserve participation across phases through redistribution into alternate pods or environments rather than participant removal, thereby maintaining engagement while still restructuring competitive dynamics. The policy can be selected based on segment duration, template constraints, and a target competitiveness metric.

In some implementations, the authoring engine computes a difficulty parameter d_m for each phase. The difficulty parameter can be derived from segment energy and position within the track (e.g., higher difficulty near later choruses) and can be bounded to prevent abrupt spikes. One example mapping is d_m=clamp (d_base+a·E_m+B.pos_m, d_min, d_max), where E_m is a normalized energy measure for segment m and pos_m is a normalized track position. The computed difficulty parameter can be translated into template-specific controls such as obstacle density, AI aggressiveness, projectile speed, or time pressure.

After selecting a template for a segment, the authoring engine instantiates template parameters based on segment features and design constraints. For example, a racing template may be instantiated with a track length proportional to segment duration, an obstacle spawn rate proportional to onset density, and a maximum speed cap based on the estimated tempo. A combat template may be instantiated with enemy spawn schedules or hazard patterns timed to downbeats detected in the segment.

One example objective function for template assignment is: Obj=Σ_m(A_m−λ1·LoadCost_m−λ2·RepeatPenalty_m−λ3·SwitchPenalty_m), where A_m is an alignment score between g_m and the selected template for segment m, LoadCost_m estimates computational and memory costs associated with transitioning to the selected template, RepeatPenalty_m penalizes undesirable repetition, and SwitchPenalty_m penalizes excessive genre switching when configured to do so. The λ parameters can be tuned per game title or per platform.

The authoring engine can select a sequence of templates {template_m} for segments subject to global constraints. Example constraints include: (i) a maximum number of mode switches within a track, (ii) limits on repeating the same template in adjacent segments, (iii) a maximum asset load budget per transition, (iv) a maximum concurrent instance count for podded phases, and (v) requirements that specific narrative beats occur at specific times. In some implementations, the selection is performed by solving a constraint satisfaction problem or an integer optimization problem. In other implementations, the selection is performed by a greedy procedure followed by local search that iteratively swaps templates to improve an objective score while satisfying constraints.

For each playable segment, the authoring engine identifies a set of candidate phase templates whose duration constraints are satisfied by the segment duration and whose player-count constraints are compatible with the configured match size. In some implementations, the engine scores candidate templates using an alignment function align (g_m, template_j) that measures compatibility between segment musical characteristics and gameplay intensity characteristics. For example, a high-energy chorus segment may be aligned to a high-intensity combat or obstacle-dodging template, while a low-energy bridge may be aligned to exploration or a low-action puzzle template.

The authoring engine can classify each segment into a role such as playable phase, transition phase, results phase, or narrative/cinematic phase. One example deterministic classifier uses thresholds on duration and cue strength: segments shorter than a threshold duration (e.g., <5 s) or associated with a large cue strength may be classified as transition segments; segments in a target playable duration range may be classified as playable; and designated end-of-track segments may be classified as results segments.

For each selected song segment [t_m, t_{m+1}), the system computes a segment feature summary g_m from the previously computed audio features. Example segment features include mean and variance of energy, tempo stability, onset density, harmonic complexity (e.g., chroma entropy), and a cue profile describing the strength and timing of the segment boundaries. Segment features can be stored in the song map as metadata for later runtime adaptation.

In some implementations, the system maintains a library of parameterized phase templates. Each phase template may be represented as a record including: (i) a gameplay mode identifier, (ii) permitted player counts and pod sizes, (iii) target duration range (e.g., D_min_mode and D_max_mode), (iv) required or optional asset sets, (v) a scoring function identifier and its parameters, (vi) a difficulty parameterization schema (e.g., spawn rates, AI aggressiveness, obstacle density), and (vii) transition requirements (e.g., whether a non-playable interval is required for initialization).

In some implementations, the Level Design process of FIG. 5 is performed wholly or partially by a computerized authoring engine that generates a song map and associated per-phase gameplay configurations from a selected segmentation configuration and a set of design constraints. The authoring engine can operate in a fully automated mode or in a hybrid mode in which a human designer approves or edits outputs.

### Exemplary Runtime Gameplay: Phase Progression and Transitions

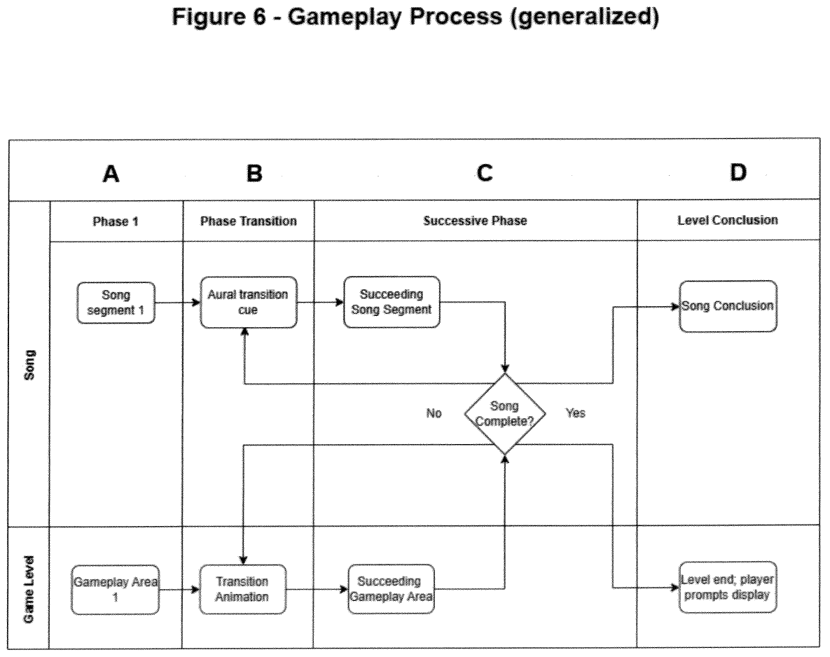

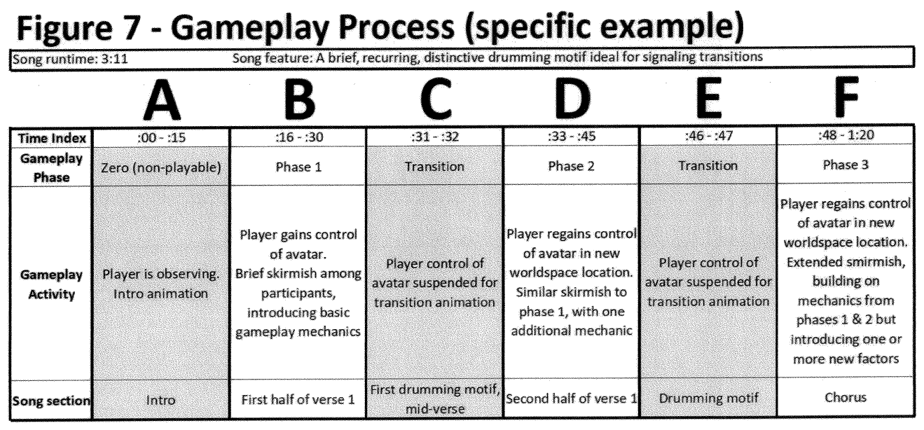

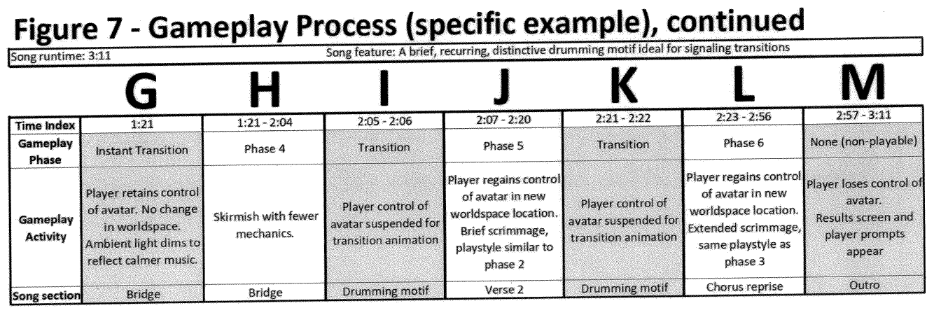

Once a phase-synchronous level is authored and set up as described, the runtime behavior of the system (Step 3 of the pipeline shown in FIG. 1) can be understood with reference to FIG. 6 (a generalized exemplary timeline diagram) and FIG. 7 (a specific example timeline). In essence, at runtime the game engine treats the chosen song as an authoritative clock that drives the game through various states.

FIG. 6 provides a schematic depiction of how gameplay and the song timeline align over time. The diagram in FIG. 6 shows two parallel lanes: a Game Level lane (representing what's happening in the game world) and a Song Timeline lane (representing the progression of the music). Time advances from left to right for both. Corresponding positions on the two lanes line up vertically, indicating synchronization at any given moment.

FIG. 6, Part A: During a first playable phase, the Game Level lane shows an active gameplay segment—for example, a particular track or arena where players are currently competing. During this same interval, the Song lane shows a corresponding song segment 622 is playing (e.g., the first verse of the song). Players are fully engaged in gameplay here, trying to achieve whatever objectives are set for Phase 1.

FIG. 6, Part B: As time approaches the end of the first segment, a transition interval occurs. On the Song lane, at the moment the first segment ends and the next one is about to begin, there is typically an aural transition cue in the music—for instance, a drum fill or a brief pause that leads into the next section. The Game Level lane enters a small non-playable segment at this same time. In this interval, the gameplay of Phase 1 has just ended, and Phase 2 has not yet started. The system may display a quick transition overlay or animation to the players, potentially including a recap of the phase's score, results, or ranking, either for that participant alone or a summary of all participants. This could be as simple as a flash on the screen or an audio-visual indicator that Phase 1 is complete, corresponding with the drum fill.

FIG. 6, Part C: Once the new song segment begins, the system transitions into the next playable phase. This begins after the transition. In the Game Level lane, a new gameplay area or mode becomes active for Phase 2. This could be a different environment entirely or a modified version of the previous setting, depending on the design (for example, a new track for a race or a transformed arena). On the Song lane, the next song segment (e.g., the chorus) is now playing. Player control is restored immediately at the start of this segment, so players are now playing Phase 2 in sync with the chorus music.

FIG. 6, Part D: This loop of playable phase->transition->next phase repeats for as many phases as the song map defines. Eventually, the song reaches its end or final section. FIG. 6, Part D indicates the final part of the timeline: after the last playable phase concludes, when the song reaches its conclusion, the game enters a final non-playable segment or results display. Often, the song's outro or final sustained note is used as an opportunity to show the final scores, winner announcements, or other post-match information, thereby concluding the gameplay in musical sync.

FIG. 7 is an expanded timeline example that illustrates a concrete sequence of phases and transitions for a song of approximately 3 minutes 11 seconds in length. This figure is divided into parts A through M, each corresponding to a specific time slice of the song and indicating what occurs in the gameplay at those times (the labels and timings are illustrative for this example and will vary for different songs and games):

FIG. 7, Part A (0:00-0:15): The song's first 15 seconds serve as a non-playable intro phase 702. For example, during this interval the game may show an opening cutscene, a title sequence, or a brief tutorial overlay while the song's intro music plays. Players hear the intro but do not yet have control of gameplay elements; this ensures all players are synchronized and ready. It sets the stage and builds anticipation without requiring immediate action.

FIG. 7, Part B (0:16-0:30): At 15 seconds into the song, Phase 1 (playable) 704 begins—perhaps corresponding to the first verse of the song. Players are now given control of their characters/vehicles and can start actively playing. This phase lasts roughly 15 seconds in the example (0:16 through 0:30). Gameplay in this phase could be the first challenge or race section where players earn points or vie for position according to the phase's rules.

FIG. 7, Part C (0:31-0:32): A brief transition interval 706 occurs around the 0:30-0:32 mark (maybe just a beat or two in length, on the order of 1-2 seconds). Suppose the song has a quick drum break between the verse and chorus. The game uses this moment to pause gameplay: Phase 1 is declared complete. Because this transition is extremely short, the game may simply freeze the action momentarily and flash a “Phase 1 Complete!” message or sound, without a lengthy animation. This is essentially an instantaneous transition-just enough of a pause to mark the boundary.

FIG. 7, Part D (0:33-0:45): Phase 2 (playable) 708 runs from 0:33 to 0:45 (about 12 seconds), which could correspond to the first chorus or another high-intensity section. New gameplay begins with potentially different mechanics or an added twist to reflect the chorus's energy. If podding is used, Phase 2 may have players grouped or split differently than in Phase 1 (for example, if Phase 1 was a qualifying round, Phase 2 may only include the top half of players racing in a smaller group, or Phase 2 may include the top half of players in one group and the bottom half in another).

FIG. 7, Part E (0:46-0:47): Another transition interval 710 of ~1-2 seconds occurs between Phase 2 and Phase 3. For example, if the song has a one-bar instrumental break at 0:45-0:47; the game uses that as a natural break to end Phase 2. A quick cutscene or sound plays during this break, indicating to players that Phase 2 is over and Phase 3 is about to begin.

FIG. 7, Part F (0:48-1:20): Phase 3 (playable) 712 starts at 0:48 and runs longer-roughly 32 seconds (maybe covering a double-length section or an extended chorus/verse combination in the song). Gameplay resumes with a new scenario or rule set for this phase. This could be a mid-song challenge that is lengthier, giving players more time to compete or collaborate. By Phase 3, the game may have ramped up in difficulty or introduced new mechanics.

FIG. 7, Part G (~1:21): At approximately 1:20-1:21, an instant transition 714 is shown. Here, assume the music makes an abrupt shift into a bridge at 1:21 with virtually no gap (perhaps a sudden drop or immediate change). In this case, the game may transition to Phase 4 almost instantaneously at 1:21, since the song doesn't provide a long break. The system can still handle this by triggering the next phase exactly on the beat of the change-possibly with a minimal cue like a flash. This demonstrates that transitions can be very short or even instantaneous if the music demands; the engine is capable of a hard cut to the next phase when needed.

FIG. 7, Part H (1:21-2:04): Phase 4 (playable) 716 spans about 43 seconds from ~1:21 to 2:04 (e.g., the bridge or a slow-build section of the song). The gameplay in Phase 4 could be something different yet again-if earlier phases were competitive, maybe this phase is a cooperative challenge, or if earlier phases were combat, maybe this is a traversal or puzzle segment. The phase length here is longer, which may allow deeper mechanics or strategy to play out.

FIG. 7, Part I (2:05-2:06): A quick transition interval 718 occurs around 2:05. Often, before the final chorus or climax, songs include a brief pause or drum fill; that serves as a phase break here between Phase 4 and Phase 5. The game may show a short camera pan or play a sound (“Get ready for the finale!”) during this one-second breather.

FIG. 7, Part J (2:07-2:20): Phase 5 (playable) 720 covers a shorter section, say 13 seconds from 2:07 to 2:20. Perhaps this is a breakdown or a short solo section musically, and the game uses it as another quick gameplay phase-possibly a bonus round or a sudden-death mini-challenge that can swing the scores a bit before the final phase.

FIG. 7, Part K (2:21-2:22): Another very quick transition interval 722 at ~2:21-2:22 marks the end of Phase 5. This could be just a single beat or crash leading into the final chorus.

FIG. 7, Part L (2:23-2:56): Phase 6 (playable) 724 runs from 2:23 to 2:56 (~33 seconds) and likely corresponds to the final chorus or climax of the song. This is the last active gameplay phase and probably the most intense, since it is the culmination of the match. All remaining players (possibly merged back into one group if they were podded) compete or collaborate here, and due to the phase-normalized scoring, everyone knows this phase can heavily influence the final outcome. The design may intentionally weight this final phase more, or simply the psychological knowledge that “this is the big finish” keeps players engaged.

FIG. 7, Part M (2:57-3:11): The song's last segment (2:57 to 3:11, about 14 seconds) is used as a non-playable results interval 726. In music terms, this may be an outro or repeated chorus fading out. Instead of extending gameplay, the designers choose to conclude active competition at 2:56 and use the remaining time to display final results. On screen, players now see the end-of-match summary: scores, rankings, perhaps a podium or celebration for the winner. The music continues to play the outro in the background, providing a satisfying sense of closure.

The FIG. 7 example above demonstrates one way to map an entire song to a sequence of gameplay phases and intervals. In practice, every song and level will have its own unique mapping. Some songs may naturally yield 3 or 4 phases, others 8 or more; some phase transitions may be long enough to have elaborate cutscenes, while others are split-second swaps. The unifying principle is that each transition is scripted according to the song map-they are predetermined events synchronized to the music, not random or purely reactive occurrences. The game engine's phase scheduler ensures that when the music's timeline hits those specified points, the corresponding actions (ending one phase, starting the next, showing a transition animation, etc.) are executed in the game.

### Exemplary Song Map Data Structures and Authoring

In certain embodiments, the timing and configuration of phases are driven by the song map data structure. The song map is typically loaded by the game at runtime and read by a phase scheduling system. Depending on the implementation, a song map can be a structured file (e.g., JSON or XML), a set of scriptable objects in the game engine, or other data constructs. It contains an ordered sequence of phase records, each representing one phase (playable or non-playable) of the level.

Each phase record may include fields such as:
Phase identifier or label: e.g., an index or name like “Phase 3-Chorus1” to uniquely identify the phase.—Start time and end time: the timestamps (or musical measure indices) within the audio track where this phase begins and ends. This defines the phase boundary timing in the song.
Gameplay configuration identifier: a reference to the rule set or game mode for this phase. This could point to a preset in the game engine (for example, “Mode=Racing” or “Mechanic=PuzzleChallenge”) or a bundle of parameters that defines the gameplay (like gravity settings, character abilities, camera perspective, etc.). It ensures the correct mechanics are activated for that segment.
Transition instructions: details on how to handle the transition into this phase. For instance, it may specify a particular transition animation or effect to play at the start (fade, cutscene ID, “Ready. . . . Go!” cue), any delay before players gain control, and whether the phase starts immediately at the music cue or after a short countdown.
Scoring configuration: how scoring works in this phase. This could include what actions yield points, and how (or if) the score from this phase will be normalized when combining with other phases. For example, the record may indicate that this phase's raw score will be converted to a rank-based score, or that this phase's points count double in final tally.
Grouping (podding) rules: if dynamic regrouping is used going into or out of this phase, the song map can specify the policy. For example, a phase record may note, “After Phase 2, split players into two pods by rank,” or “After this phase, merge all pods back into one.” This tells the runtime system how to redistribute players for the next phase.
Phase type flag: indicating whether the phase is playable or non-playable (or a subtype like “transition” or “results”). Non-playable phases would not require a gameplay configuration, but may have a specified UI or cinematic to display.
Optional events/cues within the phase: While not full phase transitions, a phase record (or a related structure) may list key moments inside the phase where something should happen in sync with the music (e.g., at 10 seconds into the phase, trigger an in-phase event because the song has a beat drop). These are more granular scripting points and are used to enhance the phase's internal choreography without ending the phase.

An authoring workflow or tool may be provided to make creating song maps easier. Developers may see a visual timeline of the song's waveform, where they can insert markers for phase boundaries and label them, assign configurations from dropdown menus for each phase, and specify transitions. The tool may import suggestions from an automated analysis (as described in Song Assessment) to pre-populate initial segment markers. The designer can then adjust those markers, merge or split segments, and assign gameplay metadata. They can also simulate or scrub through the timeline to verify that transitions line up with musical cues. Once satisfied, the tool exports the data as the song map.

By separating the song-specific data (in the song map) from the game's core logic, the system enables scalable content creation. Designers can author new levels for new songs simply by making new song maps and associated assets, without changing the underlying game code. The phase scheduler and engine logic are generic-they read whatever the song map specifies. This means the same game can support many tracks and level experiences, each with unique phase progressions, by providing a new map for each track.

### Runtime Audio Synchronization and Phase Scheduling

At runtime, the system plays back the predetermined audio track and uses it as a master clock to drive the game session. All players in the session hear the same music, and the game's state changes (phase transitions, events, etc.) are tied to specific timestamps of the audio. Achieving tight synchronization between the audio and gameplay across all players' machines is critical for fairness and experience.

In an exemplary networked implementation, a client-server architecture is used. A central game server coordinates the multiplayer session and enforces the timing of events, while each player participates via a client device (which could be a PC, console, etc.) that handles local rendering and input. The server maintains the authoritative game state and the current timeline position of the song for the match. At the start of the match, the server initiates playback of the audio track-either by streaming the audio to clients or by instructing each client to begin playing a local copy of the track at a specified start time. A synchronization signal (for example, a countdown or a “start on 3 . . . 2. . . 1 . . . now” message) can be sent so that all clients commence music playback in unison or within a very small tolerance.

Throughout the match, the server runs an Audio Sync Module that tracks the current playback time (or beat count) of the song. If clients are playing the audio locally, the server may periodically broadcast timing updates or corrections. For instance, every few seconds the server may send a message like, “Server timestamp: 90.000 seconds elapsed in song,” allowing clients to correct any drift (clients whose local clock is slightly ahead may pause for a few milliseconds, those behind may skip ahead slightly). In some embodiments, the server could be the one actually streaming the audio data in real-time to all clients, which inherently keeps them in sync, but this can be bandwidth-intensive; alternatively, each client has the audio file and just needs to stay aligned on time.

The phase scheduler component monitors the shared audio time continuously. It knows from the loaded song map exactly when each phase boundary is supposed to occur (e.g., “Phase 2 starts at 90.0s into the track”). As those moments approach, the scheduler readies the system for the transition. In some implementations, a short pre-trigger is used: for example, 0.5 seconds before a phase boundary, the server may send a “prepare to transition” event to all clients. The clients can then start loading assets for the next phase or perform other pre-transition tasks. Then, at the exact phase boundary timestamp, the server issues the command to actually transition to the next phase. Because all clients are synced to the server's clock for the music, they all receive this command effectively simultaneously and switch phases in lockstep.

When a phase transition occurs, the game executes a sequence of actions nearly instantaneously:—It finalizes the ending phase: stopping or freezing gameplay activity for that phase.—It collects final performance metrics from that phase for each player (e.g., each player's score, rank, time, health remaining, or other relevant stats).—It applies the podding rules for the upcoming phase (if any). Based on the performance metrics, it determines new pod assignments. For example, if the rule is to split top vs. bottom, it sorts players by the metric and splits the list. If the rule is to merge, it combines previously separate groups.—It communicates these new groupings to the clients. This may involve informing certain client instances that some players have been removed or added to their local view because those players moved pods.—Meanwhile, the engine loads or activates the next phase's gameplay configuration: new environment, mechanics, UI, etc., as specified in the song map. Ideally, much of this was preloaded in the seconds leading up to the transition (using a prefetch window as described), so the change can be seamless.

Often, a transition overlay or animation is displayed during the few seconds of the phase boundary. This hides any visual pops from loading or repositioning. For example, an overlay may be a full-screen effect (white flash, fade through black, a quick cutscene) lasting perhaps 1-3 seconds. During that overlay, the system may teleport or reposition player avatars to the starting positions for the next phase and reset certain game states. If, say, Phase 2 is going to take place in a completely different arena than Phase 1, the game would load that new arena in the background and then instantly swap to it at the moment of transition, showing the overlay to mask the change. Player characters may be moved into appropriate spawn points in the new arena. Any advantages or carry-over states from the previous phase can be cleared or normalized at this time (unless intentionally designed otherwise).

When the scheduled start time of the next phase arrives (which coincides with the music's downbeat of the new segment), the game removes the overlay and restores player controls. Now Phase 2 (for example) is fully underway, and players interact under the new rules until the next boundary is reached. This cycle repeats for each subsequent phase.

The system has to account for network latency such that all players transition together. The approach of syncing to a common music timeline and using predictive “prepare” signals helps mitigate latency. Clients are essentially running in a synchronized manner dictated by the server's timing. Minor variations in network delay can be handled by slight client-side adjustments; for example, if one client receives the “phase transition now” command a few milliseconds late, it can still execute it aligned to the correct timestamp (since it knows from the music clock when the transition should happen).

In some embodiments, to further guard against desynchronization, clients may use time-stretching techniques on the audio (in extreme cases). For instance, if one client falls behind by, say, 50 milliseconds due to a brief slowdown, it could slightly speed up its audio playback (without changing pitch, using DSP techniques) for a short while to catch up to the server's announced time. However, in a well-functioning system with low latency, such measures are rarely noticeable to players.

In certain embodiments it also important for the system to handle cheating or anomalies. Since the server is authoritative on time and game state, a malicious client cannot simply slow down their local music to gain more time; the server will detect that their inputs are out of sync or late relative to the global timeline and can disqualify or resynchronize them. Essentially, the song's timeline acts as a non-negotiable schedule that all clients must follow.

Summarizing the runtime control: in certain embodiments the game's progression is locked to the song's progression. Players cannot pause, delay, or accelerate the match without pausing or altering the music for everyone (which in a competitive scenario is not allowed). This creates a unique rhythm to gameplay: bursts of activity and resets that mirror the musical dynamics. Intense action ramps up with the chorus, then perhaps everyone gets a breather during a short breakdown, then another burst, all ending exactly with the song's last note. The result is a multiplayer experience orchestrated by music, with the system ensuring that technical synchronization and fairness are maintained throughout.

### Exemplary Dynamic Multiplayer Podding

One of the innovative multiplayer features in the disclosed system in certain embodiments is the ability to dynamically regroup players between phases (the “podding” discussed earlier). To provide a clearer picture, consider how a live match may play out with podding:

Suppose 12 players start a match together. Phase 1 is a free-for-all race that includes all 12 players in one track. At the end of Phase 1, the system ranks players 1 through 12 based on their performance (e.g., finishing position or points). Now the song map specifies that for Phase 2, players will be split into three pods of 4 players each. Using a winners/bracket approach, players ranked 1-4 go to Pod A, 5-8 to Pod B, and 9-12 to Pod C. These pods will compete or collaborate separately in Phase 2 (perhaps Phase 2 is a battle arena game that works best with 4 players per instance).

All pods still hear the same music and Phase 2 lasts the same fixed duration for everyone (say 20 seconds for the chorus). However, players in different pods do not interact with each other during this phase-effectively, three parallel matches are happening. Because each pod is smaller, the gameplay can be more focused (less chaos than 12-player free-for-all) and can be tailored (e.g., each pod is placed in a smaller arena suitable for 4 players, or the highly-ranked pod is in a more difficult/complex worldspace than the lower-ranked pod).

At the end of Phase 2, the system again evaluates results. Now perhaps the design calls for merging into two pods for Phase 3. For example, the song map may indicate: after Phase 2, take the top 2 players from each of the previous pods (so 6 players total) and put them in Pod X (the “finalist pod”), and put the remaining 6 players in Pod Y (a consolation pod). Then Phase 3 may proceed with two pods of 6 players each in parallel.

Alternatively, the regrouping could be done differently—the rules may reshuffle everyone irrespective of prior pods, or eliminate some players entirely if the game is in an elimination mode. The flexibility is there to design various tournament-like flows, all within one song.

From a technical standpoint, when pods are created, the server essentially spawns separate instances or isolated areas for each pod's gameplay. Players are assigned to these instances and do not see or affect players in other instances. Communication is partitioned appropriately. When pods merge, the server brings those players into a shared instance again (which may involve loading a common level or migrating their connections to one server instance). Phase transition intervals can hide these changes: for example, a quick cutscene of drop-ships moving players, as described earlier, can mask teleporting players from separate pods into one place.

One aspect of podding in certain embodiments is that time is consistent across pods. Regardless of what each pod is doing, they all know that Phase 2 will end at, say, timestamp 60.0s of the song. No pod can extend its phase or lag behind; each phase's maximum available objectives and/or physical worldspace boundaries, by design, far exceed that which a player would be able to fully reach within the time limit, such that players doing well and players doing poorly will all still be in pursuit of greater rank when the phase ends. . . . Similarly, if another pod hasn't “finished” some task by the phase end, that phase still ends for them because the song moved on (those players may be scored on partial progress or given a timeout fail for that phase). This design keeps the pods in lockstep and prevents any one group from holding up the others.

Dynamic podding, when used, provides multiple benefits in certain embodiments:
Scalability: A game can support a larger number of players by not forcing them all into one arena at once. For example, 50 players could start in Phase 1, then be divided into smaller matches after that, then perhaps only the top 10 reunite for a final phase.
Competitive balance: Players who perform poorly in early phases may get grouped with others of similar performance later, so they still have someone to compete closely with (e.g., for 5th place) rather than just being hopelessly behind the leader.
Variety: It allows mixing different competitive structures within one match. Early phases could feel like a free-for-all, mid phases like bracketed mini-tournaments, and final phase like a championship round.

The disclosed system's architecture handles all the behind-the-scenes instantiation and merging of game sessions to make this possible in real time at phase boundaries.

### Phase-Based Scoring and Normalization of Results

Scoring in the phase-synchronous system in certain embodiments is partitioned by phase, and combining those phase results into an overall outcome is an important design element. As noted, the intent is to avoid a runaway leader scenario and keep later phases meaningful. Several approaches can achieve this, and the system is flexible to accommodate different scoring rules as specified in the song map or game logic.

One straightforward scheme is a rank-point system: at the end of each phase, players are awarded points based on their standing in that phase (for example, 1st place=N points, 2nd=N−1, etc., or some predetermined scale). These points accumulate across phases. This way, even if a player dominated Phase 1 (they only get N points, not an infinite lead), another player who wins Phase 2 and Phase 3 could overtake them. If each phase is equally weighted in points, consistent high placement is rewarded, but an early slip doesn't doom a player's chance for comeback.

Another approach is to use raw scores from gameplay (like distances, damage, or points collected in each phase) but normalize them when aggregating. For example, after each phase, the maximum carry-over points may be capped to a certain value, points may be scaled such that the first place gets, for example, 10 aggregate points, second gets 8, etc., regardless of the raw difference. Later phases may also be given multipliers—e.g., Phase 1 counts 1×, but Phase 4 counts 2×—to emphasize performance in the later part of the match, giving trailing players a chance to catch up with a strong finish.

Some implementations may choose to fully reset scores to zero at the start of each phase (essentially treating each phase like a separate round in a tournament). In that case, overall winners may be determined by the count of phase victories or a final phase result. However, doing a full reset every time may undercut the value of earlier phases, so often a hybrid is used: partial carry-over of points combined with resets or caps.

If pods are involved, scoring combination also needs to handle that in certain embodiments. One method is to allocate equal phase points within each pod and then compare across pods later. For example, if in a given phase there were two pods each with their own rankings, 1st in each pod may be given the same reward. Alternatively, if it is necessary to compare across pods, all players may be ranked by some performance metric even if they did not compete head-to-head (though that can be tricky in certain embodiments if conditions differ). The simpler and fair approach in some embodiments generally is to treat pods separately for phase awards, then merge those scores later.

The phase-normalized scoring concept ultimately ensures that doing well in one phase gives an advantage, but not an insurmountable one. And doing poorly in one phase is a setback, but not elimination (unless it is an elimination game by design). This stands in contrast to continuous scoring games where a big early lead often means victory is nearly assured. Here, the design encourages comeback opportunities—for instance, a player who was last in Phase 1 could still win the match if they rally and win later phases, especially if those later phases have higher weight or if the scoring resets each time.

Game designers can fine-tune the aggressiveness of normalization. They can even introduce dynamic adjustments; for example, if one player wins the first three phases, the system may (transparently) increase the point value of the remaining phases to give others a fighting chance (analogous to final rounds in quiz shows being worth more points). Any such rules would typically be pre-defined and known to players for fairness.

Finally, once the final phase concludes, the system aggregates all the phase results according to the chosen scheme and produces the final standings. This is often displayed in the final non-playable interval or immediately after the song ends. It may list each phase's winner and then show how the totals added up to determine the champion, which helps players understand and accept the outcome. For example, a results screen may show: “Phase 1: Alice won (10 pts), Phase 2: Bob won (10 pts), Phase 3: Carol won (10 pts), Final Scores: Alice 25, Bob 22, Carol 20—Alice is the overall winner.” This reinforces that even though different people may have “won” individual phases, the overall is what counts and was still up for grabs until the end.

The combination of dynamic podding and phase-normalized scoring effectively replaces the need for hidden rubber-band mechanics. Instead of invisibly handicapping players to keep things close, the game openly structures the competition into discrete rounds and score resets that naturally tighten the field. Players are aware of the rules and can strategize around them (for instance, they know that doing well is important, but also that a final phase win could outweigh earlier performances, so they stay motivated).

Preferably, in certain embodiments phase transitions are automatic and driven solely by the predetermined timeline of the audio track, not by user selection or on-the-fly triggers. The game will move to the next phase at the exact time prescribed by the song map, regardless of what players are doing or how well they are performing. Players cannot delay or accelerate the progression; the song's structure serves as a global clock and scheduler for the gameplay. The game is synchronized at the segment level of the music (versus the beat-level synchronization in rhythm games).

The system in certain embodiments does not rely on continuous beat-matching as the core interaction. The gameplay in each phase can be of essentially any genre (racing, shooting, platforming, etc.), and does not require players to press buttons to the beat. The music is used for pacing and cues for transitions, but not necessarily as a strict input timeline. This broadens the application beyond the music game genre, effectively making the song a backdrop and orchestrator for diverse gameplay rather than the object of gameplay itself.

Competitive balance is maintained in certain embodiments through explicit phase breaks and score normalization rather than continuous background adjustments. Certain embodiments use the structure of the game (multiple phases with resets) to prevent early leads from deciding the match. This is transparent: players know that after each phase there will be a reset or new grouping, which is analogous to having multiple rounds in a tournament. It avoids the subtle unfairness players sometimes feel, since here everyone is aware that each phase starts anew to some degree.

In certain embodiments, the overall architecture can be seen as a time-partitioned control system for a multiplayer match. Instead of one continuous session, the match may be split into segments, each potentially running in its own controlled context (even separate server instances for pods), with a higher-level controller (the phase scheduler tied to the song) managing transitions and state transfers. This is somewhat analogous to single-player games that have multiple chapters or levels, but condensed into one continuous experience guided by a song. This partitioning provides design flexibility (each phase can try a different mechanic safely contained in its time window) and resilience (a mistake or failure in one phase doesn't immediately end the game; players can recover in the next phase).

In certain embodiments, a single-user implementation may operate without any additional human or artificial intelligence-controlled participants. In such configurations, the phase-synchronous architecture remains fully operative and does not depend on the presence of competitors or collaborators. Phase boundaries, gameplay mode transitions, environmental reconfiguration, and routing logic continue to be governed by the predetermined audio timeline and associated song map.

In a single-participant session, phase routing may be determined based on spatial state parameters of the participant at a phase boundary, including world coordinates, region membership, elevation, environmental interaction state, or other positional attributes. For example, the participant's physical location within the virtual world at the conclusion of a phase may determine which subsequent phase instance, environment, or ruleset is activated, independent of the presence of other participants.

Additionally or alternatively, routing decisions in a single-user configuration may be based on performance metrics, including completion time, score achieved within a phase, comparison to stored prior personal best results, leaderboard benchmarks, or predefined threshold criteria. The participant may therefore be assigned to different subsequent phases, difficulty configurations, or environmental variations based on comparison to historical or reference performance data, even when no other active participants are present in the session.

Accordingly, phase progression, branching, regrouping logic, environmental differentiation, and score normalization mechanisms described herein may operate in competitive multiplayer, cooperative multiplayer, hybrid, or fully single-participant implementations, and the absence of additional participants does not alter the underlying phase-synchronous control structure.

In certain embodiments, phase progression within a phase-synchronous gameplay system may depend on state information generated during one or more preceding phases. Such state information may include, for example, player performance metrics, spatial state parameters, environmental interaction states, or other gameplay-derived data associated with a participant or game entity at or near a phase boundary.

For example, a participant's physical position within the virtual environment at the conclusion of a phase may influence which subsequent gameplay phase, environment configuration, ruleset, or asset set is activated. In some embodiments, spatial state parameters evaluated at the phase boundary may include world coordinates, elevation, region membership, proximity to environmental triggers, collision states, or other physical interactions with the environment. Based on such parameters, the system may route the participant to a different gameplay environment, level instance, or gameplay configuration for the subsequent phase.

By way of illustration, a gameplay environment may include a frozen lake region during a first phase. Participants who remain on the surface of the lake at the conclusion of the phase may transition to a mountainous terrain phase in the subsequent segment of the audio track, while participants that have fallen through the ice may transition to an underwater cave phase. In this example, the physical worldspace state of the participant at the phase boundary determines which subsequent phase instance is executed.

In other embodiments, phase routing may depend on performance metrics generated during the preceding phase. Such metrics may include scores, completion times, distance traveled, resource acquisition, survival duration, or other gameplay measurements. These metrics may be compared against thresholds, historical performance records, leaderboard benchmarks, or predefined difficulty criteria to determine how the subsequent phase should be configured.

In certain embodiments, the subsequent phase configuration may be modified by altering one or more of the following parameters: gameplay rules or mechanics, environmental layout or worldspace region, difficulty parameters, available player abilities or resources, obstacle placement, opponent or non-player entity behavior, scoring rules, phase duration, or asset sets associated with the environment.

Importantly, such phase conditioning may occur even when only a single participant is present in the gameplay session. In a single-participant implementation, routing decisions may be based on the participant's own performance metrics, historical best results, stored ghost data, leaderboard comparisons, or spatial state conditions without requiring the presence of additional competitors or collaborators.

Thus, the phase-synchronous architecture described herein may operate in competitive multiplayer environments, cooperative multiplayer environments, hybrid gameplay configurations, or fully single-participant sessions. In each case, gameplay progression remains synchronized to predetermined phase boundaries associated with the audio track, while phase configuration, routing, or environmental selection may be dynamically conditioned on gameplay state information derived from prior phases.

In some embodiments, multiplayer gameplay sessions may include dynamic regrouping of participants into distinct gameplay pods or instances at phase boundaries based on performance metrics. In contrast, single-participant embodiments may instead modify phase configuration parameters, environment selection, or gameplay difficulty without performing participant regrouping. Both approaches operate within the same underlying phase-synchronous control framework.

These mechanisms enable branching gameplay progression and adaptive difficulty scaling while maintaining synchronization with the underlying audio timeline.

In certain embodiments, gameplay configuration changes may include modifications to control mappings or input interpretations between phases. For example, a control input that performs a first action in one gameplay phase may perform a different action in a subsequent gameplay phase in response to phase-dependent gameplay rules or environmental context.

In sum, the disclosed systems in certain embodiments create a gaming experience that is neither purely a rhythm game nor a traditional static-structure game, but a hybrid that leverages a song's narrative arc to structure a competitive or cooperative experience.

### Exemplary Computing System

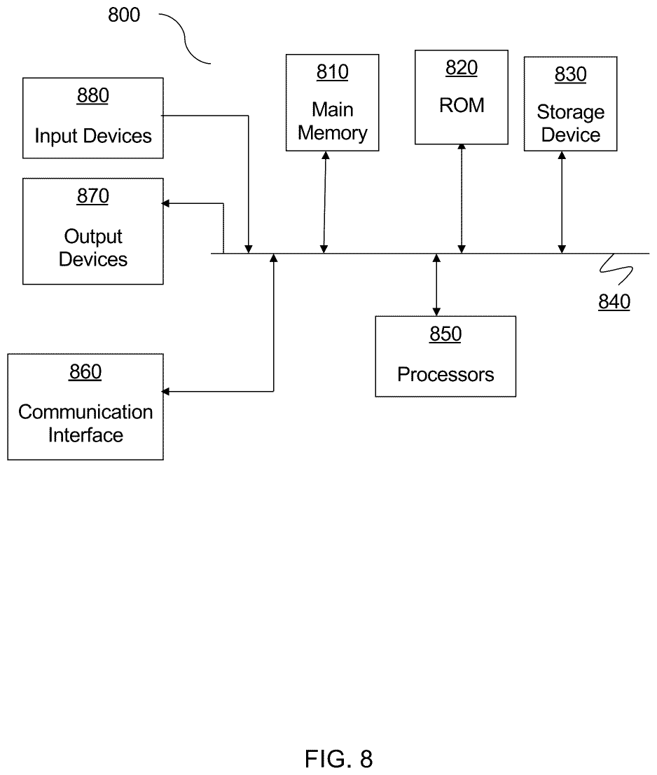

FIG. 8 is a block diagram illustrating an example computing system 800 that may be used to implement one or more components of the game system described herein (for example, the server or a client device in the multiplayer environment). Computing system 800 is depicted in a generalized form to represent a wide variety of actual computing devices, including but not limited to game consoles, desktop or laptop computers, smartphones and tablets, or cloud servers.

As shown, the computing system 800 includes one or more processors 850. These could be general-purpose CPUs, specialized processors like GPUs or DSPs for handling graphics or signal processing, or any combination thereof. The processor(s) execute program instructions that implement the game logic, audio synchronization, networking, and other functionality described.

The system has a system bus or interconnect 840 that links together its components for communication. Coupled to the processor are memory components. Main memory 810 (e.g., RAM) provides fast, volatile storage for code and data in use, allowing quick access by the processor during gameplay execution. The system may also include read-only memory (ROM) 820 or other persistent memory that stores low-level system code or bootstrapping instructions.

Storage devices 830 provide non-volatile storage for larger amounts of data. These may be hard drives, solid-state drives, flash memory modules, optical drives, or similar devices. In the context of this game system, storage devices on a server may hold the library of songs and precomputed song maps for levels, game databases, etc. On a client device, storage devices may hold the installed game software, assets for local levels, and possibly downloaded song map content or audio tracks for synchronization.

The computing system also interfaces with various input devices 880 and output devices 870. Input devices 880 can include the usual peripherals: game controllers, keyboards, mice, touchscreens, motion sensors (like cameras for body tracking or gyroscopic sensors in a device), microphones (for voice commands), etc. Depending on the requirements of each particular implementation, input devices may include dedicated game controllers, mobile computing devices, smartphones, tablets, handheld gaming systems, laptop computers, or desktop computing systems, as well as motion-sensing devices, touch-sensitive displays, wearable devices, or other interactive input mechanisms. These capture the player's actions and feed them into the game. In a music-synchronized game, specialized controllers (like instrument-shaped controllers or dance pads) could also be considered, although the disclosed system is not limited to rhythm inputs.

Output devices 870 include the display (TV, monitor, or device screen) that shows the game visuals, speakers or headphones that output the music and game sounds, and possibly haptic feedback devices (such as vibration motors in controllers) that could respond to events like phase transitions. Many modern devices combine input and output (e.g., a smartphone touchscreen both displays and takes touch input, or a VR headset has displays and motion sensors together).

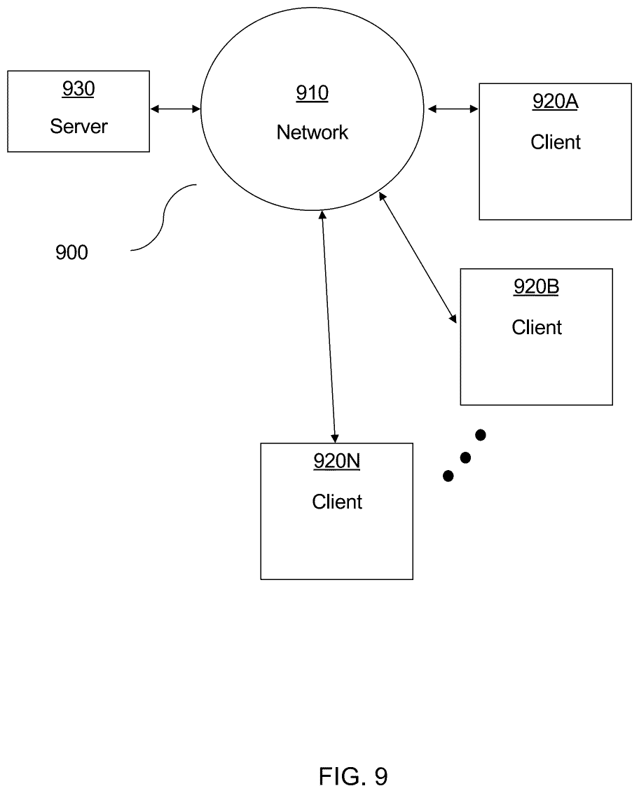

The computing system 800 uses one or more communication interfaces 860 to connect with networks and other devices (as will be illustrated in FIG. 9). These interfaces could be wired (Ethernet, USB for tethering) or wireless (Wi-Fi, Bluetooth, cellular radios). In a multiplayer game scenario, the communication interface is what enables the client to send input to and receive updates from the game server, and for the server to broadcast timing signals, state changes, and so on. High-speed, low-latency communication is often crucial; thus, games may use UDP for rapid state sync or TCP for reliability where needed, or a combination.

It should be understood that FIG. 8 is a conceptual representation. In practice, the distribution of these components can vary. A server in a data center may have many processors and large memory pools, whereas a handheld device may system-on-chip combining CPU, GPU, and memory. Also, some implementations may distribute tasks: for instance, in a cloud gaming setup, the server may do rendering and send video to a thin client.

Regardless of specific hardware layout, any device that runs the described software functions (song tracking, phase scheduling, etc.) will include processing, memory, storage, input/output, and networking capabilities as described, in order to perform the methods of this disclosure.

### Exemplary Networked Environment

FIG. 9 illustrates an example networked environment 900 for implementing phase-synchronous multiplayer gameplay. In this environment, multiple client devices 920A . . . 920N (representing the players' computers, consoles, or mobile devices) are connected via one or more networks 910 to a game server 930 (or servers).

The network(s) 910 can be a combination of local networks (like a home LAN or a campus network) and wide-area networks such as the Internet. Players in the same local network may have a more direct low-latency connection, whereas players across the globe communicate over the Internet backbone. The system is designed to work in both cases. Network 810 may include wired links (Ethernet, fiber) as well as wireless links (Wi-Fi, cellular data). All networking techniques available for online multiplayer games are applicable here.

In a typical deployment, the game server 930 hosts the authoritative game logic. It runs a server version of the game software that maintains the official state of the match: the current phase, the positions and scores of players, the timing of the song, etc. Each client 920A . . . 920N runs a client version of the game software that presents the game to the local player and sends that player's inputs to the server. The server 930 ensures all clients remain synchronized to the song and enforces rules (to prevent cheating, resolve conflicts, etc.). For example, in certain embodiments, when it is time to transition phases, the server 930 sends out a “phase transition” command to all clients (possibly with an exact timestamp to execute it, as discussed). The clients all comply and load the next phase's content.

The environment can also include auxiliary servers or services not shown explicitly in FIG. 9, such as matchmaking servers (to arrange which players are in a session together), relay servers (to help NAT traversal), or content delivery networks (to provide the audio tracks and assets to clients). However, once a match is underway, the core interaction is between game server 930 and clients 820A . . . 820N. In some embodiments, peer-to-peer networking could be used (eliminating a central server), but even then one peer often acts as a host that takes on the timing authority role. For competitive integrity and simplicity, a client-server model is preferred so that timing and state are centrally managed.

Synchronizing the audio across all clients in a networked environment is a key aspect of this system. The server 930 may start the audio at all clients simultaneously by sending a start signal. It may periodically send timing updates as described. Clients may also measure their local clock against server timestamps (similar to NTP-Network Time Protocol-synchronization) to adjust any drift. In an implementation where clients have the audio file locally, the server may say “start playback at exactly 00:00:05 UTC” for all clients. If a client happens to start late by a few milliseconds, it could speed up slightly to catch up.

The depiction of multiple clients and one server in FIG. 9 is simplified. In a large-scale cloud gaming scenario, there could be multiple servers for different regions or to handle different phases of computation (one server handling physics, another handling audio sync, etc.). But logically, as far as each client is concerned, it communicates with a host authority that dictates the music timeline and game state.

The outcome for players in this environment in certain embodiments is that they experience a synchronized gameplay session. They could be geographically far apart, but the music and phase transitions happen for everyone at the same moments. The architecture ensures that even with network latency, strategies like buffering and time correction keep the experience in lockstep.

The features and embodiments described above may be combined or modified in various ways without departing from the scope of the disclosed concepts. For example, while many descriptions herein assume a competitive multiplayer scenario, the same system can be adapted to cooperative multiplayer gameplay. In a cooperative mode, all players may work together toward a common goal through the phases (for instance, collectively surviving waves of enemies that intensify with each musical phase). Podding in co-op could be used to split a large team into sub-teams tackling different objectives in parallel phases, and scoring would be team-based rather than individual.

The architecture likewise supports single-player experiences. A single human player can play through the phase-synchronized level with the other “competitors” represented by AI-controlled bots. In such an embodiment, the system may fill the pods with computer-controlled opponents that follow the rules and provide challenge, so the lone player still experiences the dynamic phase transitions, regrouping (with bots moving in and out of their competition), and phase-wise scoring as if it were a multiplayer match. This allows the gameplay format to be enjoyed solo or with any number of human players, with AI agents making up the rest of the participants as needed.

The phase branching concept described can be employed to create secret or alternate paths through the level. For example, designers may include a hidden final phase (with its own unique music segment or an extension of the song) that only triggers if certain criteria are met (e.g., all players survive through the prior phases, or a player achieves a high score in each phase). In that case, the song map would define an alternate ending segment and the condition for switching to it. Even in branching scenarios, the key is that timings remain predetermined; if the alternate phase is used, it fits into the same overall timeline or a slight extension that was planned (some games may have a secret ending that plays a bonus track or an extended outro if triggered).

The aesthetic and genre of the game can vary widely. One implementation of the system may present as a realistic 3D racing-combat hybrid, another may be a cartoon 2D platformer that uses indie music tracks. The core synchronization and phase logic remain the same. The system may synchronize to non-musical timed media (like a narration track or a scripted sequence), though music provides a particularly rich guiding structure.

On the technical side, in certain embodiments any division of labor between server and client can be considered as long as the timing guarantees are met. In some cases, clients may do more work (for instance, if network conditions are poor, a client may locally predict phase transitions based on its own clock and then later reconcile with the server). In other cases, a central server or cloud service may handle almost everything including rendering (with the client just streaming video). The design is agnostic to these implementation details; what matters is that the logical functionality-phase scheduling to music and consistent state management—is achieved.

### Example Multiplayer Phase Routing Based on Performance Metrics and Spatial State

The phase-synchronous architecture described herein may support dynamic routing of participants between phases based on multiple independent criteria including performance metrics and spatial state parameters within the virtual environment. The following example illustrates one non-limiting multiplayer implementation in which participant placement evolves across successive phases of gameplay synchronized to an audio track.

In the example configuration, eight participants (identified as A through H) initially participate in a single shared gameplay environment during a first phase. At the conclusion of the first phase, each participant receives a ranking determined by performance metrics generated during that phase.

During Phase 1, all participants occupy a single unified worldspace. At the conclusion of the phase, the following rankings are determined: participant D ranks first, participant B ranks second, participant F ranks third, participant C ranks fourth, participant A ranks fifth, participant E ranks sixth, participant H ranks seventh, and participant G ranks eighth.

During Phase 2, the system dynamically reassigns participants into two pods executed in duplicate worldspaces. In this example, the reassignment is performed using a high-low pairing approach intended to balance competitive difficulty across the pods. Participants are therefore distributed as follows: Pod 1: participants B, D, G, and H; Pod 2: participants A, C, E, and F.

Within Phase 2, participants compete only against other participants assigned to their respective pod environments. Each pod produces an internal ranking for that phase. In this example, the resulting rankings are: Pod 1: B ranks first, H ranks second, D ranks third, G ranks fourth; Pod 2: F ranks first, C ranks second, E ranks third, A ranks fourth.

During Phase 3, all participants return to a single shared worldspace. In this example embodiment, the worldspace begins atop a frozen lake environment. The mechanics of the phase allow participants to fall through openings in the ice if certain gameplay conditions occur. As a result, participants may end the phase either above the frozen lake surface or inside the submerged interior of the lake.

At the conclusion of Phase 3, participants occupy different spatial locations based on their gameplay outcomes. For example, participants B and D remain above the ice surface, while participants A, C, E, F, G, and H fall below the ice and occupy the interior lake region.

During Phase 4, routing of participants is determined solely by the spatial state of each participant at the end of Phase 3. Participants that remained above the ice are placed into a mountain worldspace, while participants located below the ice are placed into a frozen cave worldspace. Each worldspace executes as a separate gameplay instance synchronized to the same audio timeline.

In this example, participants B and D enter the mountain worldspace, while participants A, C, E, F, G, and H enter the frozen cave worldspace. Each environment produces an independent ranking outcome within that phase.

During Phase 5, the system again performs dynamic regrouping. In this embodiment, four pods are created using a high-high pairing approach to generate head-to-head finales. Participants are paired according to the rankings achieved in Phase 4 such that similarly ranked participants compete directly with one another. For example: Pod 1: participant B paired with participant F; Pod 2: participant D paired with participant A; Pod 3: participant H paired with participant C; Pod 4: participant G paired with participant E.

Each pod executes its final gameplay instance independently, thereby producing a series of head-to-head finales within the final segment of the audio track.

This example illustrates that participant routing across phases may be determined by a combination of performance metrics and spatial state parameters, and that both types of routing decisions may occur within the same phase-synchronous gameplay session.

### Example Single-Participant Phase Routing

The same phase-synchronous architecture may operate in a single-participant environment in which no additional participants are present.

In a single-participant embodiment, gameplay phases remain synchronized to the audio track and phase routing decisions may be based on the participant's own performance metrics or spatial state within the virtual environment.

For example, during Phase 1, the participant may play within a worldspace designed to evaluate the participant's skill level. Based on the resulting performance grade from Phase 1, the system may determine the configuration of Phase 2.

In one example, if the participant receives a high grade in Phase 1, the system may present a high-difficulty configuration of the Phase 2 worldspace. If the participant receives a lower grade, the system may instead present a modified configuration of the same worldspace including fewer obstacles, additional resources, or alternate traversal paths.

During Phase 3, the participant may again enter a unified worldspace environment. In this example, the environment begins atop a frozen lake similar to the multiplayer example described above. If the participant successfully navigates the mechanics of the phase, they remain above the ice. If the participant fails certain mechanics, they may fall through the ice and enter the interior of the lake.

During Phase 4, the system routes the participant to a subsequent environment based on the participant's spatial state at the conclusion of Phase 3. Participants that remain above the ice may transition to a mountain zone, while participants that fall through the ice may transition to a frozen cave zone.

During Phase 5, the system may again modify the gameplay configuration based on cumulative performance metrics across the preceding phases. In some embodiments, a public zone may be presented in which gameplay mechanics are adjusted based on the participant's aggregate performance score. In other embodiments, if the participant achieved sufficiently high performance within the mountain zone during Phase 4, the system may instead route the participant to a secret zone that is otherwise inaccessible.

Importantly, this routing and phase configuration logic may operate even in the absence of any additional participants. The system therefore supports dynamic branching gameplay progression in both multiplayer and single-participant implementations while maintaining synchronization with the audio track.

It will be appreciated that all components and steps described in this specification can be used in any combination or sub-combination. Different embodiments may include only a subset of the features or may have specialized adaptations of the processes for particular game genres or hardware platforms.

The foregoing description of embodiments of the invention has been presented for the purpose of illustration. It is not intended to be exhaustive or to limit the invention to the precise embodiments discussed above. Persons skilled in the art will appreciate that many modifications and variations are possible in light of the above teaching. The scope of the disclosed subject matter is defined by the claims that follow. The claims are intended to cover insubstantial variations and equivalents of the expressly recited elements and limitations, consistent with applicable law governing equivalents.

What is claimed is:

1. A computer-implemented gameplay system comprising one or more processors and memory storing instructions that cause said one or more processors to execute a gameplay session synchronized to a discrete audio track, the system configured to:
execute a first gameplay phase using a first gameplay configuration during a first segment of said discrete audio track;
automatically transition, at a phase boundary associated with playback of said discrete audio track, to a second gameplay phase executed during a subsequent segment of said discrete audio track; and
determine a second gameplay configuration for said second gameplay phase based at least in part on gameplay state information generated during said first gameplay phase.

2. A computer-implemented method comprising:
analyzing a discrete audio track to identify a plurality of candidate phase boundaries, based on associated audio track data;
generating a song map defining gameplay phases corresponding to segments of said audio track;
associating each said segment with a unique gameplay configuration based on characteristics of said corresponding audio track segment; and
executing gameplay transitions automatically between said gameplay phases during playback of said discrete audio track based on said song map.

3. A computer-implemented gameplay system comprising one or more processors and memory storing instructions that cause said one or more processors to execute a gameplay session synchronized to a discrete audio track, the system configured to:
execute a plurality of gameplay phases, each synchronized to a corresponding segment of said discrete audio track;
automatically transition, at phase boundaries associated with playback of said discrete audio track, between said gameplay phases; and
vary at least one gameplay configuration in each said gameplay phase based on said phase's associated audio track data.

4. The system of claim 1, wherein said gameplay state information comprises performance metrics from said first gameplay phase.

5. The system of claim 4, wherein said performance metrics comprise score values generated during said first gameplay phase.

6. The system of claim 4, wherein said performance metrics comprises distance traveled within a gameplay environment.

7. The system of claim 4, wherein said performance metrics comprise completion time for a gameplay objective.

8. The system of claim 1, wherein said gameplay state information comprises rankings derived from performance metrics.

9. The system of claim 1, wherein said gameplay state information comprises one or more spatial state parameters of one or more participants within a virtual environment.

10. The system of claim 9, wherein said one or more spatial state parameters comprise world coordinates of said one or more participants.

11. The system of claim 9, wherein said one or more spatial state parameters comprise elevation within said virtual environment.

12. The system of claim 9, wherein said one or more spatial state parameters comprise environmental interaction status.

13. The system of claim 9, wherein said one or more spatial state parameters are evaluated at the time of the phase boundary.

14. The system of claim 1, wherein said gameplay state information comprises comparison of performance metrics against stored historical performance data.

15. The system of claim 1, wherein said gameplay state information comprises total number of participants.

16. The system of claim 1, wherein said gameplay session comprises multiple participants and a configuration of said second gameplay phase comprises regrouping participants into a plurality of gameplay pods.

17. The system of claim 16, wherein said configuration of said gameplay pods corresponds to separate identical gameplay environments executed concurrently.

18. The system of claim 16, wherein said configuration of said gameplay pods corresponds to separate distinct gameplay environments executed concurrently.

19. The system of claim 1, wherein said second gameplay phase configuration modifies worldspace layout relative to said first gameplay phase.

20. The system of claim 1, wherein said second gameplay phase configuration comprises a different gameplay genre relative to said first gameplay configuration.

21. The system of claim 1, wherein said second gameplay phase configuration comprises modifying at least one of gameplay mechanics, environmental layout, gameplay difficulty parameters, available resources, or opponent behavior.

22. The method of claim 2, wherein said gameplay phases are synchronized with bar or beat positions in said discrete audio track.

23. The method of claim 2, wherein identifying candidate phase boundaries comprises detecting structural segments of said discrete audio track.

24. The method of claim 2, wherein generating said song map includes assigning gameplay configurations based on segment duration.

25. The method of claim 2, wherein candidate phase boundaries correspond to changes in musical intensity.

26. The method of claim 2, wherein candidate phase boundaries correspond to tempo variations.

27. The method of claim 2, wherein generating said song map comprises assigning environmental configurations for gameplay phases.

28. The system of claim 3, wherein said gameplay configuration comprises worldspace size or layout.

29. The system of claim 3, wherein said gameplay configuration comprises participant count.

30. The system of claim 3, wherein said gameplay configuration comprises gameplay genre.

31. The system of claim 3, wherein said gameplay configuration comprises alterations to game control input definitions or functionality.

32. The system of claim 3, wherein said gameplay configuration comprises gameplay mechanics.

33. The system of claim 3, wherein audio track data associated with each of said gameplay phases comprises a duration of a corresponding segment of said discrete audio track.

34. The system of claim 3, wherein audio track data associated with each of said gameplay phases comprises instrumentation analysis of a corresponding segment of said discrete audio track.

35. The system of claim 3, wherein audio track data associated with each of said gameplay phases comprises intensity or tempo of a corresponding segment of said discrete audio track.
